(19) United States
(12) Patent Application Publication
(10) Pub. No.: US 2021/0350620 A1
(43) Pub. Date: Nov. 11, 2021

(54) GENERATIVE GEOMETRIC NEURAL NETWORKS FOR 3D SHAPE MODELLING

(71) Applicant: Imperial College Innovations Limited, London (GB)

(72) Inventors: Michael Bronstein, London (GB); Shunwang Gong, London (GB); Mehdi Bahri, London (GB); Georgios Bouritsas, London (GB); Stefanos Zafeiriou, London (GB); Sergiy Bokhnyak, London (GB)

(73) Assignee: Imperial College Innovations Limited, London (GB)

(21) Appl. No.: 16/869,294

(22) Filed: May 7, 2020

(51) Int. Cl. G06T 17/20; G06N 20/00; G06N 3/04; G06F 17/16

(52) U.S. Cl. CPC G06T 17/20; G06F 17/16; G06N 3/04; G06N 20/00

(57) ABSTRACT

A method for generating output geometric domain data is disclosed. The geometric decoder method comprises receiving an input comprising at least an input representation and decoding the input to generate an output geometric domain by applying on the input representation at least an intrinsic convolution layer, wherein the intrinsic convolutional layer comprises a consistent local ordering of data points on the geometric domain.

### STATEMENT REGARDING PRIOR DISCLOSURES BY THE INVENTOR OR A JOINT INVENTOR

The following three articles are grace period inventor disclosures by one or more joint inventors: (1) Bouritsas et al., Neural 3D Morphable Models: Spiral Convolutional Networks for 3D Shape Representation Learning and Generation, 2019, pages 1-10; (2) Gong et al., Geometrically Principled Connections in Graph Neural Networks, 2020, pages 1-15; (3) Gong et al., SpiralNet++: A Fast and Highly Efficient Mesh Convolution Operator, 2019, pages 1-8.

### FIELD

The present invention relates to generating an output geometric domain.

### BACKGROUND

The success of deep learning in computer vision and image analysis, speech recognition, and natural language processing, has driven the recent interest in developing similar models for 3D geometric data. Generalisations of successful architectures such as convolutional neural networks (CNNs) to data with non-Euclidean structure (e.g. manifolds and graphs) is known under the umbrella term Geometric deep learning. In applications dealing with 3D data, the key challenge of geometric deep learning is a meaningful definition of intrinsic operations analogous to convolution and pooling on meshes or point clouds. Among numerous advantages of working directly on mesh or point cloud data is the fact that it is possible to build invariance to shape transformations (both rigid and nonrigid) into the architecture, as a result allowing to use significantly simpler models and much less training data. So far, the main focus of research in the field of geometric deep learning has been on analysis tasks, encompassing shape classification and segmentation, local descriptor learning, correspondence, and retrieval.

On the other hand, there has been limited progress in representation learning and generation of geometric data (shape synthesis). Obtaining descriptive and compact representations of meshes and point clouds is essential for downstream tasks such as classification and 3D reconstruction, when dealing with limited labelled training data. Additionally, geometric data synthesis is pivotal in applications such as 3D printing, computer graphics and animation, virtual reality, and game design, and can heavily assist graphics designers and speed-up production. Furthermore, given the high cost and time of acquiring quality 3D data, geometric generative models can be used as a cheap alternative for producing training data for geometric ML algorithms.

Most of the previous approaches in this direction rely on intermediate representations of 3D shapes, such as point clouds, voxels or mappings to a flat domain instead of direct surface representations, such as meshes. Despite the success of such techniques, they either suffer from high computational complexity (e.g. voxels) or absence of topological information in the data representation (e.g. point clouds), while usually pre- and post-processing steps are needed in order to obtain the output surface model. Learning directly on the mesh was only recently explored in for shape completion, non-linear facial morphable model construction and 3D reconstruction from single images, respectively.

### SUMMARY

According to a first aspect of the invention there is provided a geometric decoder method comprising receiving an input comprising at least an input representation; and decoding the input to generate an output geometric domain by applying on the input representation at least an intrinsic convolution layer, wherein the intrinsic convolutional layer comprises a consistent local ordering of data points on the geometric domain.

The output geometric domain may be selected from the group consisting of: a manifold; a parametric surface; an implicit surface; a mesh; a point cloud; an undirected weighted or unweighted graph; or a directed weighted or unweighted graph.

The input may comprise a consistent local ordering.

The input representation may be a vector.

The output geometric domain may comprise point data and structure data.

The structure data may be selected from the group consisting of: a neighbour graph; a triangular mesh; or a simplicial complex.

The point data may be computed and the input may comprise the structure data.

The structure data may be a template geometric domain.

Determining the consistent local ordering of data points may comprise determining the local neighbours of each data point on the geometric domain and ordering said local neighbours in a consistent way.

The consistent local ordering of data points may comprise the local neighbours of each data point along a trajectory, the trajectory being selected from the group consisting of: a spiral; or a set of one or more concentric circles.

The consistent local ordering of data points may be generated, for each point, by: selecting a first point; selecting a second point adjacent to said first point; selecting a clockwise or counter-clockwise direction; selecting the next point in the selected direction around the first point on the geometric domain which is closest to the first point and which has not already been selected; and performing the previous step until a desired number of points have been selected.

Selecting the second point may comprise fixing the first point on a template domain; selecting the second point wherein the second point has the shortest geodesic distance to the first point on the template domain.

Applying intrinsic convolution layer may comprise the steps of: obtaining the consistent local ordering of data points on the geometric domain; extracting features associated with each of said data points; applying a set of weights to the extracted features using the consistent local ordering of data points to compute a new set of output features; and outputting the output features.

The set of weights may be determined by a learning procedure.

The learning procedure may include an optimization procedure to find an optimal set of weights that minimize a loss function on a training set of examples.

A plurality of intrinsic convolutional layers may be applied in sequence.

The output of a previous layer may be provided as the input to a subsequent layer. The intrinsic convolutional layers may further be interleaved with non-linear activation functions, fully connected layers, and pooling layers.

The plurality of intrinsic convolutional layers may be applied on a hierarchy of geometric domains. For example, a hierarchy of meshes may be obtained by progressive coarsening procedure or hierarchy of graphs obtained by progressive graph coarsening.

The hierarchy of geometric domains may comprises at least one of: a hierarchy of point data; a hierarchy of structure data.

At least some of the subsequent geometric domains in the hierarchy of geometric domains may be supersets of the previous geometric domains in the hierarchy of geometric domains.

The method may further comprise applying an upsampling operation between the application of each intrinsic convolutional layers.

The upsampling operation may transfer data across two subsequent geometric domains. For example, the upsampling operation may interpolate the data on the vertices of a fine mesh from the data on the vertices of a coarse mesh.

Each geometric domain in the hierarchy of geometric domains may comprise a respective consistent local ordering of data points on said geometric domain.

The input representation may be generated by an encoder applied to input data.

The input data may be selected from the group consisting of one of: an image; a point cloud; a mesh; a manifold; an implicit surface; a signed distance function; a parametric surface; or a graph.

The encoder may be selected from the group consisting of one of: a convolutional neural network; a point cloud neural network; a convolutional mesh neural network; or a graph neural network.

The encoder architecture may be identical to that of the decoder.

The encoder architecture may be identical to that of the decoder and applied in the reverse order.

The encoder may comprise at least an intrinsic convolution layer.

The method may further comprise at least one affine skip connection.

The method may further comprise at least one affine skip connection across at least two intrinsic convolution layers.

The method may further comprise at least one affine skip connection in at least one of the decoder or encoder.

The affine skip connection between two intrinsic convolutional layers may comprise summing a affine transformation of the output of a layer with the output of another layer

The affine transformation effected by a affine skip connection may be implemented as a series of at least one fully connected layers

An affine skip connection may be implemented with exactly one fully connected layer

The method may further comprise summing the output of the affine skip connection with the subsequent convolutional layer.

The method may comprise receiving a first set of geometric domain data and extracting hierarchical features from the first set of geometric domain data by applying an intrinsic convolution layer on the first set of geometric domain data. The convolutional layer may comprise a consistent local ordering of vertices around a first vertex of the first set of geometric domain data. The method may further comprise storing the hierarchical features of the first set of geometric data as a second set of geometric domain data.

Features from the first set of geometric data are aggregated in the second set of geometric data.

The intrinsic convolutional layer may be applied directly on the first get of geometric domain data, that is, on the vertices of the data themselves.

Using the connectivity of the geometric domain data (e.g. a graph) with a filter comprising a consistent local ordering of vertices (e.g. a spiral convolutional filter), may allow for local processing of each geometric domain data (e.g. a shape, for example a human hand or face), while the hierarchical nature of the model may allow learning in multiple scales. In this way we may learn semantically meaningful representations and considerably reduce the number of parameters. Furthermore, the need to make assumptions about the distribution of the data may be bypassed. Such a method may work directly with geometric domain data represented in the form of a mesh, graph, point cloud, etc. The model generated by the method may require significantly fewer parameters than standard approaches, and it can therefore be trained with much less data and may be less prone to overfitting.

The consistent local ordering of vertices may be generated by selecting a second vertex adjacent to the first vertex, selecting a clockwise or counter-clockwise direction, selecting the next vertex in the selected direction around the first vertex on the geometric data which is closest to the first vertex and which has not already been selected; and performing the previous step until a desired number of vertices have been selected.

Selecting the second vertex may comprise fixing the first vertex on a template shape and selecting the second vertex wherein the second vertex has the shortest geodesic distance to the first vertex on the template shape.

The number of vertices in the consistent local ordering of vertices is between 5 and 20. The number of vertices in the consistent local ordering of vertices is between 8 and 12. The number of vertices in the consistent local ordering of vertices is 9 or 10.

The convolutional layer may comprise a dilated convolution. The dilated convolution may be generated by subsampling the consistent local ordering of vertices.

The intrinsic convolution layer may be applied using a patch operator.

The method may further comprise iteratively applying the intrinsic convolutional layer to the output of the application of the intrinsic convolutional layer to generate the second set of geometric data.

The geometric domain may be one of: a manifold; a parametric surface; an implicit surface; a mesh; a point cloud; an undirected weighted or unweighted graph; or a directed weighted or unweighted graph.

The method may further comprise after applying the intrinsic convolutional layer to the first set of geometric data, applying at least one down-sampling layer to the output of the intrinsic convolutional layer.

The method may further comprising iteratively applying the intrinsic convolutional layer and the down-sampling layer to the first set of geometric domain data to generate the second set of geometric domain data.

At least one of the down-sampling layers may be a pooling layer.

Applying the pooling layer may further comprise determining a subset of vertices of the output of the intrinsic convolutional layer; and for each vertex of the subset, determining the neighbouring vertices in the geometric domain; and aggregating input data of the neighbours for all the vertices of the subset.

The method may further comprise applying a linear layer and/or a non-linear layer and/or a flattening layer to the first set of geometric domain data and/or the output of the previous layer.

The second set of geometric domain data may be a fully connected layer.

The method may comprise receiving a first set of geometric domain data containing hierarchical features and generating a second set of geometric domain data by extrapolating the hierarchical features from the first set of geometric domain data by applying an intrinsic convolution layer directly on the first set of geometric domain data; where the convolutional layer may comprise a consistent local ordering of vertices around a first vertex of the first set of geometric domain data.

Thus, by applying the intrinsic convolutional layer directly to the geometric domain data containing hierarchical features, the model can be used to generate meaningful geometric representations. These representations may be of for example, human facial expressions, hand gestures and the like. As the method works directly with the geometric domain data, the method may require significantly fewer parameters than standard approaches and may be less prone to overfitting.

The hierarchical features of the first set of geometric domain data may be extracted from a third set of geometric domain data.

The features from the second set of geometric data are extrapolated in the third set of geometric data.

The consistent local ordering of vertices may be generated by selecting a second vertex adjacent to the first vertex; selecting a clockwise or counter-clockwise direction; selecting the next vertex in the selected direction around the first vertex on the geometric data which is closest to the first vertex and which has not already been selected; and performing the previous step until a desired number of vertices have been selected.

Selecting the second vertex may comprise fixing the first vertex on a template shape and selecting the second vertex wherein the second vertex has the shortest geodesic distance to the first vertex on the template shape.

The number of vertices in the consistent local ordering of vertices is between 5 and 20. The number of vertices in the consistent local ordering of vertices is between 8 and 12. The number of vertices in the consistent local ordering of vertices is 9 or 10.

The convolutional layer may comprise a dilated convolution.

The dilated convolution may be generated by subsampling the consistent local ordering of vertices.

The intrinsic convolution layer may be applied using a patch operator.

The method may further comprise iteratively applying the intrinsic convolutional layer to the output of the application of the intrinsic convolutional layer to generate the second set of geometric data.

The geometric domain may be one of: a manifold; a parametric surface; an implicit surface; a mesh; a point cloud; an undirected weighted or unweighted graph; or a directed weighted or unweighted graph.

The method may further comprise, after applying the intrinsic convolutional layer to the first set of geometric data, applying at least one up-sampling layer to the output of the intrinsic convolutional layer.

The method may further comprise iteratively applying the intrinsic convolutional layer and the up-sampling layer to the first set of geometric domain data to generate the second set of geometric domain data.

At least one of the up-sampling layers may be a de-pooling layer.

Applying the de-pooling layer may further comprise: determining a subset of vertices of the output of the intrinsic convolutional layer; and for each vertex of the subset, determining the neighbouring vertices in the geometric domain; and extrapolating input data of the neighbours for all the vertices of the subset.

The method may further comprise applying a linear layer and/or a non-linear layer and/or a flattening layer to the first set of geometric domain data and/or the output of the previous layer.

The first set of geometric domain data may be a fully connected layer.

Extrapolating the hierarchical features from the first set of geometric domain data may further comprise interpolating features of the added vertices after extrapolation by weighting the nearby vertices using barycentric coordinates.

The method may further comprise applying a distribution matching scheme to the second set of geometric domain data.

The distribution matching scheme may be a mesh Wasserstein Generative Adversarial Network; wherein a gradient penalty is applied to the network to enforce the Lipschitz constraint; and wherein the network is trained to minimise the Wasserstein divergence between the real distribution of the meshes and the distribution of those produced by the generator network.

The second set of geometric domain data may represent animal body parts. The second set of geometric domain data may represent human body parts. The second set of geometric domain data may represent a face or a hand.

The method may comprise receiving a first set of geometric domain data and extracting hierarchical features from the first set of geometric domain data by applying a first intrinsic convolution layer on the first set of geometric domain data. The first convolutional layer may comprise a consistent local ordering of vertices around a first vertex of the first set of geometric domain data. The method may further comprise generating a second set of geometric domain data by extrapolating the hierarchical features extracted from the first set of geometric domain data by applying a second intrinsic convolution layer directly on the first set of geometric domain data. The second convolutional layer may comprise a consistent local ordering of vertices around a first vertex of the first set of geometric domain data.

The first and second convolutional layers may have the same structure, for example, a spiral scan of the vertices of the geometric domain data.

There may be a computer program comprising instructions for performing the method.

There may be a computer program product comprising a computer readable medium (which may be non-transitory) storing the computer program.

There may be apparatus comprising at least one processor and memory configured to perform the method. The processor may be a central processing unit or a graphics processing unit. The processor may have one or more cores.

There may be a computer system comprising: at least one processor and a memory. The memory storing computer readable instructions that, when executed by the at least one processor, causes the computer system to perform the method of any preceding claim.

The computer system may further comprise storage for storing an input representation, extracted features and/or an output geometric domain.

### BRIEF DESCRIPTION OF THE DRAWINGS

Certain embodiments of the present invention will now be described, by way of example, with reference to the accompanying drawings, in which:

FIG. 1 illustrates a neural three-dimensional morphable model (Neural3DMM) architecture;

FIG. 2 is a spiral ordering on a mesh;

FIG. 3 is a spiral ordering on an image patch;

FIG. 4 illustrates the result of activations of ChebNet (left) and spiral convolutions (right);

FIG. 5 is a quantitative evaluation of the Neural3DMM against the baselines, in terms of generalisation and number of parameters for the COMA dataset;

FIG. 6 is a quantitative evaluation of the Neural3DMM against the baselines, in terms of generalisation and number of parameters for the DFAUST dataset;

FIG. 7 is a quantitative evaluation of the Neural3DMM against the baselines, in terms of generalisation and number of parameters for the Mein3D dataset;

FIG. 8 illustrates Spiral vs ChebNet (spectral) filters for the COMA dataset;

FIG. 9 illustrates Spiral vs ChebNet (spectral) filters for the DFAUST dataset;

FIG. 10 is a table should spirals vs soft-attention operators;

FIG. 11 is a table showing the effect of different orderings of the convolutional layer on LSTM and linear projection formulations;

FIG. 12 illustrates the Euclidian error of the reconstructions produced by PCA (2^{nd} row), COMA (3^{rd} row), and our Neural3DMM (bottom row), by colour coding of the per vertex Euclidean error Top row is ground truth;

FIG. 13 illustrates interpolations between expressions and identities;

FIG. 14 illustrates extrapolation. Left: neutral expression/pose;

FIG. 15 illustrates analogies in MeIn3D and DFAUST;

FIG. 16 illustrates generated identities from the intrinsic 3D GAN;

FIG. 17 illustrate examples of texture transfer from a reference shape in neural pose (left) using shape correspondences predicted by SpiralNet++ (middle) and SpiralNet (right). Only 3D coordinates used as input features for both methods;

FIG. 18A illustrates an example of a Spiral++ on a triangle mesh;

FIG. 18B illustrates an example of a DilatedSpiral++ on a triangle mesh. Note that the dilated version supports exponential expansion of the receptive field without increasing the spiral length;

FIG. 19 is a visualization of pointwise geodesic errors (in % geodesic diameter) of our method and SpiralNet on the test shapes of the FAUST human dataset. The error values are saturated at 7.5% of the geodesic diameter, which corresponds to approximately 15 cm. Hot colors (labelled as reds) represent large errors;

FIG. 20 is a geodesic error plot of the shape correspondence experiments on the FAUST humans dataset. Geodesic error is measured according to the Princeton benchmark protocol. The x axis displays the geodesic error in % of diameter and the y axis shows the percentage of correspondences that lie within a given geodesic error around the correct node;

FIG. 21 is a table of dense shape correspondence on the FAUST dataset. Test accuracy is the ratio of the correct correspondence prediction with the geodesic error of 0.

FIG. 22 is a table of 3D facial expression classification on the 4DFAB facial expression dataset. We present the test accuracies obtained by all the methods for each expression (i.e., anger, disgust, fear, happiness, sadness and surprise) and all the expressions. *As for the Baseline, we use the reported result in their paper.

FIG. 23 illustrates qualitative results of 3d shape reconstruction in the CoMA dataset. Pointwise error (euclidean distance from the groundtruth) is computed for visualization. The error values are saturated at 10 (millimeters). Hot colors represent large errors;

FIG. 24 is a table of the results of 3D shape reconstruction experiments results in the CoMA dataset. Errors are in millimeters.

FIG. 25 is a schematic block diagram of a first computer system;

FIG. 26 is a schematic block diagram illustrating the encoder model of the system;

FIG. 27 is a schematic block diagram illustrating the decoder model of the system;

FIG. 28 is a schematic block diagram illustrating the encoder model of the system;

FIG. 29 is a schematic block diagram illustrating the decoder model of the system;

FIG. 30 is a process flow diagram of the encoder model;

FIG. 31 is a process flow diagram of the decoder model;

FIG. 32 illustrates a comparison made between learned graph convolution kernels and RBF interpolation suggests augmenting graph convolution operators with additive affine transformations, implemented as parametric connections between layers. Our affine skip connections improve the network's ability to represent certain transformations, and enable better use of the vertex features;

FIG. 33 is a block diagram illustrating how the block learns the sum of one graph convolution and a shortcut equipped with an affine transformation;

FIG. 34 is a table of 3D shape reconstruction experiments results in the CoMA dataset. Errors are in millimeters. All the experiments were ran with the same network architecture. We show the results of each operator for different kernel sizes (i.e., # of weight matrices). Aff- denotes the operators equipped with the proposed affine skip connections, Res- denotes the operators with standard residual connections, and y indicates we remove the separate weight for the center vertex.

FIG. 35 illustrates sample reconstructions: addition of affine skip connections and ablation of the center vertex weights;

FIG. 36 is an example of reconstructed faces obtained by passing samples (top) through a trained autoencoder built on the Aff-MoNet block. The middle row shows reconstructions produced by the full autoencoder. The bottom row shows the result of passing through the affine skip connections only in the decoder at inference. The connections learn a smooth component common to the samples—across identities and expressions, as expected from the motivation;

FIG. 37 illustrate shape correspondence experiments on the FAUST humans dataset. Per-vertex heatmap of the geodesic error for three variants of the GCN operator.

FIG. 38 illustrates shape correspondence accuracy: the x axis displays the geodesic error in % of the mesh diameter, and the y axis shows the percentage of correspondences that lie within a given radius around the correct vertex. All experiments were ran with the same architecture. Aff-GCN only has 1% more parameters than GCN.

FIG. 39 is a table of classification accuracy of different operators and blocks on the Superpixel MNIST dataset with 75 superpixels. For MoNet, we report performance using pseudo-coordinates computed from the vertex positions, or from the connectivity only (vertex degrees).

FIG. 40 is a table of ablations: affine skip connection vs. self-loop. We show the performances of FeaStNet under the settings of with and without self-loop (denoted with y) and with and without affine skip connections regarding the tasks of shape reconstruction on CoMA, shape correspondence on FAUST, and classification on MNIST with 75 superpixels. M denotes the kernel size (i.e. # weight matrices). For correspondence, test accuracy is the ratio of the correct correspondence prediction at geodesic error 0.

FIG. 41 illustrates pointwise error (Euclidean distance from groundtruth) of the reconstructions by FeaStNet and MoNet (both with and without affine skip connections) on the CoMA test dataset. The reported errors (bottom-right corner of each row) represent the per-point mean error and its standard deviation. For visualization clarity, the error values are saturated at 5 millimeters. Hot colors represent large errors.

FIG. 42 illustrates the pointwise mean euclidean error of SplineCNN and Aff-SplineCNN for shape reconstruction experiments on the CoMA dataset.

FIG. 43 illustrates pointwise error (geodesic distance from groundtruth) of FeaStNet and MoNet (both with and without affine skip connections) on the FAUST humans dataset. The reported accuracy values (bottom-right corner of each row) represent the percentage of correct correspondence at geodesic error 0. For visualization clarity, the error values are saturated at 10% of the geodesic diameter. Darker colors represent large errors.

FIG. 44 illustrates pointwise error (geodesic distance from groundtruth) of FeaStNet and MoNet (both with and without affine skip connections) on the FAUST humans dataset. The reported accuracy values (bottom-right corner of each row) represent the percentage of correct correspondence at geodesic error 0. For visualization clarity, the error values are saturated at 10% of the geodesic diameter. Darker colors represent large errors.

FIG. 45 illustrates pointwise error (geodesic distance from groundtruth) of vanilla GCN, Res-GCN and Aff-GCN on the FAUST humans dataset. Aff-GCN replaces the residual connections of Res-GCN to the proposed affine skip connections. The rest are the same. The reported accuracy values (bottom-right corner of each row) represent the percentage of correspondence at geodesic error 0. For visualization clarity, the error values are saturated at 10% of the geodesic diameter. Darker colors represent large errors.

### DETAILED DESCRIPTION

Neural 3D Morphable Models: Spiral Convolutional Networks for 3D Shape Representation Learning and Generation

Generative models for 3D geometric data arise in many important applications in 3D computer vision and graphics. In this paper, we focus on 3D deformable shapes that share a common topological structure, such as human faces and bodies. Morphable Models and their variants, despite their linear formulation, have been widely used for shape representation, while most of the recently proposed nonlinear approaches resort to intermediate representations, such as 3D voxel grids or 2D views. In this work, we introduce a novel graph convolutional operator, acting directly on the 3D mesh that explicitly models the inductive bias of the fixed underlying graph. This is achieved by enforcing consistent local orderings of the vertices of the graph, through the spiral operator, thus breaking the permutation invariance property that is adopted by all the prior work on Graph Neural Networks. Our operator comes by construction with desirable properties (anisotropic, topologyaware, lightweight, easy-to-optimise), and by using it as a building block for traditional deep generative architectures, we demonstrate state-of-the-art results on a variety of 3D shape datasets compared to the linear Morphable Model and other graph convolutional operators.

In this application, we propose a novel representation learning and generative framework for fixed topology meshes. For this purpose, we formulate an ordering-based graph convolutional operator, contrary to the permutation invariant operators in the literature of Graph Neural Networks. In particular, similarly to image convolutions, for each vertex on the mesh, we enforce an explicit ordering of its neighbours, allowing a “1-1” mapping between the neighbours and the parameters of a learnable local filter. The order is obtained via a spiral scan, hence the name of the operator, Spiral Convolution. This way we obtain anisotropic filters without sacrificing computational complexity, while simultaneously we explicitly encode the fixed graph connectivity. The operator can potentially be generalised to other domains that accept implicit local orderings, such as arbitrary mesh topologies and point clouds, while it is naturally equivalent to traditional grid convolutions. Via this equivalence, common CNN practices, such as dilated convolutions, can be easily formulated for meshes.

We use spiral convolution as a basic building block for hierarchical intrinsic mesh autoencoders, which we coin Neural 3D Morphable Models. We quantitatively evaluate our methods on several popular datasets: human faces with different expressions (COMA) and identities (Mein3D) and human bodies with shape ad pose variation (DFAUST). Our model achieves state-of-the-art reconstruction results, outperforming the widely used linear 3D Morphable Model and the COMA autoencoder, as well other graph convolutional operators, including the initial formulation of the spiral operator. We also qualitatively assess our framework showing ‘shape arithmetic’ in the latent space of the autoencoder and by synthesising facial identities via a spiral convolution Wasserstein GAN.

2. Related Work

Generative models for arbitrary shapes: Perhaps the most common approaches for generating arbitrary shapes are volumetric CNNs acting on 3D voxels. For example, voxel regression from images, denoising autoencoders and voxel-GANs have been proposed. Among the key drawbacks of volumetric methods are their inherent high computational complexity and that they yield coarse and redundant representations. Point clouds are a simple and lightweight alternative to volumetric representation recently gaining popularity. Several methods have been proposed for representation learning of fixed-size point clouds using the PointNet architecture Point clouds of arbitrary size can be synthesised via a 2D grid deformation. Despite their compactness, point clouds are not popular for realistic and high-quality 3D geometry generation due to their lack of an underlying smooth structure. Image-based methods have also been proposed, such as multi-view and flat domain mappings such as UV maps, however they are computationally demanding, require pre- and post-processing steps and usually produce undesirable artefacts. It is also worth mentioning the recently introduced implicit-surface based approaches that can yield accurate results, though with the disadvantage of slow inference (dense sampling of the 3D space followed by marching cubes).

Morphable models: In the case of deformable shapes, such as faces, bodies, hands etc., where a fixed topology can be obtained by establishing dense correspondences with a template, the most popular methods are still statistical models given their simplicity. For Faces, the baseline is the PCAbased 3D Morphable Model (3DMM). The Large Scale Face Model (LSFM) was proposed for facial identity and made publicly available, Faceware-house and Learning a model of facial shape and expression from 4D scans were proposed for facial expression, while for the entire head a large scale model have been proposed. For Body & Hand, the most well known models are the skinned vertex-based models SMPL and MANO, respectively. SMPL and MANO are non-linear and require (a) joint localisation and (b) solving special optimisation problems in order to project a new shape to the space of the models. In this paper, we take a different approach introducing a new family of differentiable Morphable Models, which can be applied on a variety of objects, with strong (i.e. body) and less strong (i.e. face) articulations. Our methods have better representational power and also do not require any additional supervision.

Geometric Deep Learning is a set of recent methods trying to generalise neural networks to non-Euclidean domains such as graphs and manifolds. Such methods have achieved promising results in geometry processing and computer graphics, computational chemistry, and network science. Multiple approaches have been proposed to construct convolution-like operations, including spectral methods, local charting based and soft attention. Finally, graph or mesh coarsening techniques have been proposed, equivalent to image pooling.

3. Spiral Convolutional Networks

3.1. Spiral Convolution

Following discussion, we assume to be given a manifold discretised as a triangular mesh [symbol] =(V, [symbol] , [symbol] ) where V={1, . . . , n}, [symbol] and [symbol] denote the sets of vertices, edges, and faces respectively. Furthermore, let ƒ: V→ [symbol] , a function representing the vertex features.

One of the key challenges in developing convolution-like operators on graphs or manifolds is the lack of a global system of coordinates that can be associated with each point. The first intrinsic mesh convolutional architectures such as GCNN, ACNN or MoNet overcame this problem by constructing a local system of coordinates u(x,y) around each vertex X of the mesh, in which a set of local weighting functions wᵢ, . . . , w_{L} is applied to aggregate information from the vertices y of the neighborhood [symbol] (x). This allows to define ‘patch operators’ generalising the sliding window filtering in images:

$${( f ⋆ g )}_{x} = {\sum }_{ℓ = 1}^{L} {g}_{ℓ} {\sum }_{y ∈ 𝒩 ( x )} {𝓌}_{ℓ} ( u ( x , y ) ) f ( y ) \qquad ( 1 )$$

Where [symbol] (u(x,y))ƒ(y) are ‘soft pixels’ (L in total),ƒ are akin to pixel intensity in images, and gₗ the filter weights. The problem of the absence of a global coordinate system is equivalent to the absence of canonical ordering of the vertices, and the patch-operator based approaches can be also interpreted as attention mechanisms. In particular, the absence of ordering does not allow the construction of a “1-1” mapping between neighbouring features ƒ(y) and filter weights [symbol] , thus a “all-to-all” mapping is performed via learnable soft-attention weights [symbol] (u(x,y)). In the Euclidean setting, such operators boil down to the classical convolution, since an ordering can be obtained via the global coordinate system.

Besides the lack of a global coordinate system, another motivation for patch-operator based approaches when working on meshes, is the need for insensitivity to meshing of the continuous surface, i.e. ideally, each patch operator should be independent of the underlying graph topology.

However, all the methods falling into this family, come at the cost of high computational complexity and parameter count and can be hard to optimise. Moreover, patch operator based methods specifically designed for meshes, require hand-crafting and pre-computing the local systems of coordinates. To this end, in this paper we make a crucial observation in order to overcome the disadvantages of the aforementioned approaches: the issues of the absence of a global ordering and insensitivity to graph topology are irrelevant when dealing with fixed topology meshes. In particular, one can locally order the vertices and keep the order fixed. Then, graph convolution can be defined as follows:

$${( f ⋆ g )}_{x} = {\sum }_{ℓ = 1}^{L} {g}_{ℓ} f ( {x}_{ℓ} ) \qquad ( 2 )$$

where {x₁, . . . , x_{L}} denote the neighbours of vertex x ordered in a fixed way. Here, in analogy with the patch operators, each patch operator is a single neighbouring vertex. In the Euclidean setting, the order is simply a raster scan of pixels in a patch. On meshes, we opt for a simple and intuitive ordering using spiral trajectories. Let x∈V be a mesh vertex, and let R^{d} (x) be the d-ring, i.e. an ordered set of vertices whose shortest (graph) path to x is exactly d hops long; Rⱼ^{d} (x) denotes the jth element in the d-ring (trivially, R₀⁰(x)=x). We define the spiral patch operator as the ordered sequence

S(x)={x,R₁¹(x),R₂^{1z(x)}, . . . , R_{|R}_{^{h|}}^{h}} (3)

where h denotes the patch radius, similar to the size of the kernel in classical CNNs. Then, spiral convolution is:

$${( f ⋆ g )}_{x} = {\sum }_{ℓ = 1}^{L} {g}_{ℓ} f ( {S}_{ℓ} ( x ) ) \qquad ( 4 )$$

The uniqueness of the ordering is given by fixing two degrees of freedom: the direction of the rings and the first vertex R₁¹(x). The rest of the vertices of the spiral are ordered inductively. The direction is chosen by moving clockwise or counterclockwise, while the choice of the first vertex, the reference point, is based on the underlying geometry of the shape to ensure the robustness of the method. In particular, we fix a reference vertex x₀ on a template shape and choose the initial point for each spiral to be in the direction of the shortest geodesic path to x₀, i.e.

$${R}_{1}^{1} ( x ) = \begin{matrix}arg \\ y ∈ {R}^{1} ( x )\end{matrix} min {d}_{ℳ} ( {x}_{0} , y ) \qquad ( 5 )$$

where dM is the geodesic distance between two vertices on the mesh M. In order to allow for fixed-sized spirals, we choose a fixed length L as a hyper-parameter and then either truncate or zero-pad each spiral depending on its size.

Comparison to Lim et al. (I. Lim, A. Dielen, M. Campen, and L. Kobbelt. A simple approach to intrinsic correspondence learning on unstructured 3d meshes. Proceedings of the European Conference on Computer Vision Workshops (ECCVW), 2018): The authors choose the starting point of each spiral at random, for every mesh sample, every vertex, and every epoch during training. This choice prevents us from explicitly encoding the fixed connectivity, since corresponding vertices in different meshes will not undergo the same transformation (as in image convolutions). Moreover, single vertices also undergo different transformations every time a new spiral is sampled. Thus, in order for the network to obtain robustness to different spiral samples, it inevitably has to become invariant to different rotations of the neighbourhoods, thus it has reduced capacity. To this end, we emphasise the need of consistent orderings across different meshes.

Moreover, in Lim et al., the authors model the vertices on the spiral via a recurrent network, which has higher computational complexity, is harder to optimise and does not take advantage of the stationary properties of the 3D shape (local statistics are repeated across different patches), which are treated by our spiral kernel with weight sharing.

Comparison to spectral filters: Spectral convolutional operators which have been developed in for graphs and used for mesh autoencoders, suffer from the fact that they are inherently isotropic. This is a side-effect when one, under the absence of a canonical ordering, needs to design a permutation-invariant operator with small number of parameters. In particular, spectral filters rely on the Laplacian operator, which performs a weighted averaging of the neighbour vertices:

(Δƒ)ₓ= [symbol] w_{xy}(ƒ(y)−(ƒ(x)) (6)

where w_{xy} denotes an edge weight. A polynomial of degree r with learnable coefficients σ₀, . . . , θᵣ is then applied to Δ. Then, the graph convolution amounts to filtering the Laplacian eigenvalues, p(Δ)=Φp(Λ)Φ^{T}. Equivalently:

$$( f * g ) = p ( Δ ) f = {\sum }_{ℓ = 0}^{r} {θ}_{ℓ} {Δ}^{ℓ} f \qquad ( 7 )$$

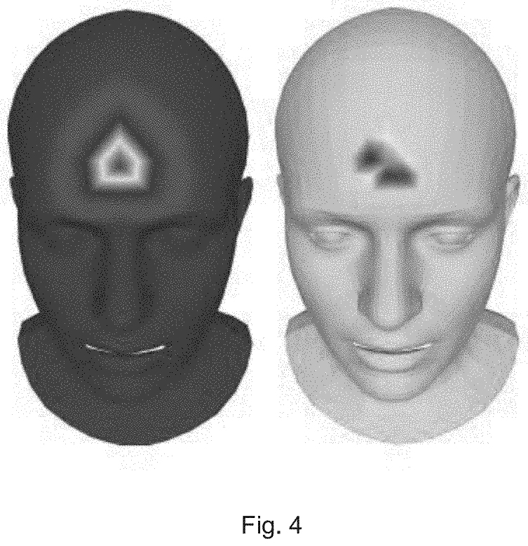

While a necessary evil in general graphs, spectral filters on meshes are rather weak given that they are locally rotationally-invariant. On the other hand, spiral convolutional filters leverage the fact that on a mesh one can canonically order the neighbours. Thus, they are anisotropic by construction and as will be shown in the experimental section 4 they are expressive by using just one-hop neighbourhoods, contrary to the large receptive fields used in some applications. In FIG. 4 we visualise the impulse response (centred on a vertex on the forehead) of a selected laplacian polynomial filter from the architecture of Ranjan et al. (A. Ranjan, T. Bolkart, S. Sanyal, and M. J. Black. Generating 3d faces using convolutional mesh autoencoders. Proceedings of the European Conference on Computer Vision (ECCV), 2018). (left) and from a spiral convolutional filter with h=1(right).

Finally, the equivalence of spiral convolutions to image convolutions may allow the use of long-studied practices in the computer vision community. For example, small patches can be used, leading to few parameters and fast computation. Furthermore, dilated convolutions can also be adapted to the spiral operator by simply sub-sampling the spiral. Finally, we argue here that our operator could be applied to other domains, such as point clouds, where an ordering of the data points can be enforced.

3.2. Neural 3D Morphable Models

Let F=[ƒ₀|ƒ₁| . . . , [symbol] ],ƒᵢ∈ [symbol] ^{d*m} the matrix of all the signals defined on a set of meshes in dense correspondence that are sampled from a distribution [symbol] , where d the dimensionality of the signal on the mesh (vertex position, texture etc.) and m the number of vertices. A linear 3D Morphable Model represents arbitrary instances y∈ [symbol] as a linear combination of the k largest eigenvectors of the covariance matrix of F by making a gaussianity assumption:

$$y \approx \overline{f} + {\sum }_{i}^{k} {α}_{i} \sqrt{{d}_{i} {v}_{i}} \qquad ( 8 )$$

where ƒ̅ the mean shape, vᵢ is the ith principal component, dᵢ the respective eigenvalue and αᵢ the linear weight coefficient. Given its linear formulation, the representational power of the 3DMM is constrained by the span of the eigenvectors, while its parameters scale linearly with respect to the number of the eigencomponents used, leading to large parametrisations for meshes of high resolution.

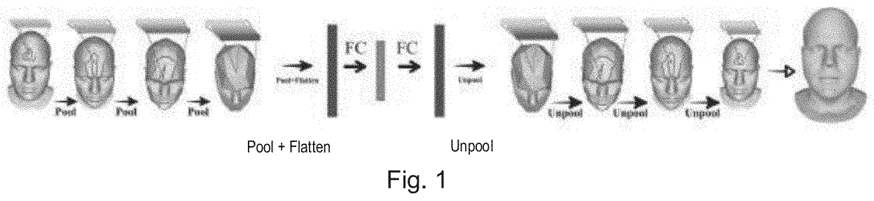

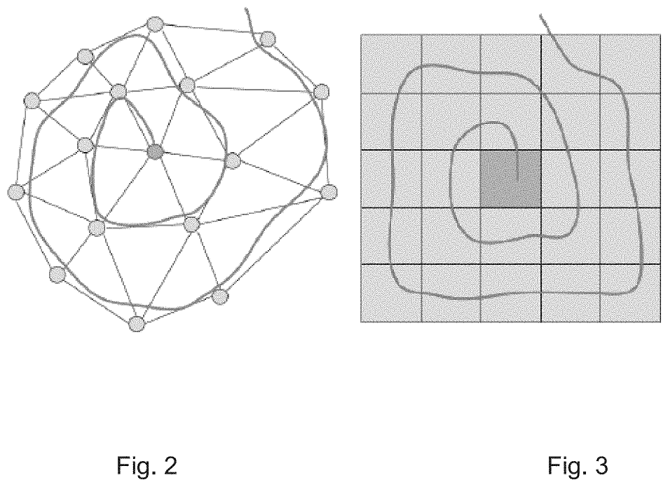

In contrast, in this paper, we use spiral convolutions as a building block to build a fully differentiable non-linear Morphable Model. In essence, a Neural 3D Morphable Model is a deep convolutional mesh autoencoder, that learns hierarchical representations of a shape. An illustration of the architecture can be found in FIG. 1. Leveraging the connectivity of the graph with spiral convolutional filters, we allow for local processing of each shape, while the hierarchical nature of the model may allow learning in multiple scales. This way we manage to learn semantically meaningful representations and considerably reduce the number of parameters. Furthermore, we bypass the need to make assumptions about the distribution of the data.

Similar to traditional convolutional autoencoders, we make use of series of convolutional layers with small receptive fields followed by pooling and unpooling, for the encoder and the decoder respectively, where a decimated or upsampled version of the mesh is obtained each time and the features of the existing vertices are either aggregated or extrapolated. We follow Ranjan et al. for the calculation of the features of the added vertices after upsampling, i.e. through interpolation by weighting the nearby vertices with barycentric coordinates. The network is trained by minimising the L₁ norm between the input and the predicted output.

3.3. Spiral Convolutional GAN

In order to improve the synthesis of meshes of high resolution, thus increased detail, we extend our framework with a distribution matching scheme. In particular, we propose a mesh Wasserstein GAN with gradient penalty to enforce the Lipschitz constraint, that is trained to minimise the wasserstein divergence between the real distribution of the meshes and the distribution of those produced by the generator network. The generator and discriminator architectures, have the same structure as the decoder and the encoder of the Neural3DMM respectively. Via this framework, we obtain two additional properties that are inherently absent from the autoencoder: high frequency detail and a straightforward way to sample from the latent space.

4. Evaluation

In this section, we showcase the effectiveness of our proposed method on a variety of shape datasets. We conduct a series of ablation studies in order to compare our operator to other Graph Neural Networks, by using the same autoencoder architecture. Fist, we demonstrate the inherent higher capacity of spiral convolutions compared to ChebNet (spectral). Moreover, we discuss the advantages of our method compared to soft-attention based Graph Neural Networks, such as patch-operator based. Finally, we show the importance of the consistency of the ordering by comparing our method to different variants of the method proposed in Lim et al.

Furthermore, we quantitatively show that our method can yield better representations than the linear 3DMM and COMA, while maintaining a small parameter count and frequently allowing a more compact latent representation. Moreover, we proceed with a qualitative evaluation of our method by generating novel examples through vector space arithmetic. Finally, we assess our intrinsic GAN in terms of its ability to produce high resolution realistic examples.

For all the cases, we choose as signal on the mesh the normalised deformations from the mean shape, i.e. for every vertex we subtract its mean position and divide with the standard deviation. In this way, we encourage signal stationarity, thus facilitating optimisation. The code is available at https://github.com/gbouritsas/neural3DMM.

4.1. Datasets

COMA. The facial expression dataset from Ranjan et al., consisting of 20K+3D cans (5023 vertices) of twelve unique identities performing twelve types of extreme facial expressions. We used the same data split as in.

DFAUST. The dynamic human body shape dataset from Bogo et al., consisting of 40K+3D scans (6890 vertices) of ten unique identities performing actions such as leg and arm raises, jumps, etc. We randomly split the data into a test set of 5000, 500 validation, and 34.5K+ train.

MeIn3D. The 3D large scale facial identity dataset from Booth et al., consisting of more than 10,000 distinct identity scans with 28K vertices which cover a wide range of gender ethnicity and age. For the subsequent experiments, the MeIn3D dataset was randomly split within demographic constraints to ensure gender, ethnic and age diversity, into 9K train and 1K test meshes.

For the quantitative experiments of sections 4.3 and 4.4 the evaluation metric used is generalisation, which measures the ability of a model to represent novel shapes from the same distribution as it was trained on. More specifically we evaluate the average per sample and per vertex Euclidean distance in the 3D space (in millimetres) between corresponding vertices in the input and its reconstruction.

4.2. Implementation Details

We denote as SC(h,w) a spiral convolution of h hops and w filters, DS(p) and US(p) a downsampling and an upsampling by a factor of p, respectively, FC(d) a fully connected layer, l the number of vertices after the last downsampling layer. The simple Neural3DMM for COMA and DFAUST datasets is the following:

Enc: SC(1; 16)→DS(4)→SC(1; 16)→DS(4)→SC(1; 16)→DS(4)→SC(1; 32)→DS(4)→FC(d)

Dec: FC(1*32)→US(4)→SC(1; 32)→US(4)→SC(1; 16)→US(4)→SC(1; 16)→US(4)→SC(1; 3)

For Mein3D, due to the high vertex count, we modified the COMA architecture for our simple Neural3DMM by adding an extra convolution and an extra downsampling/upsampling layer in the encoder and the decoder respectively (encoder filter sizes: [8,16,16,32,32], decoder: mirror of the encoder). The larger Neural3DMM follows the above architecture, but with an increased parameter space. For COMA, the convolutional filters of the encoder had sizes [64,64,64,128] and for Mein3D the sizes were [8,16,32,64,128], while the decoder is a mirror of the encoder. For DFAUST, the sizes were [16,32,64,128] and [128,64,32,32,16] and dilated convolutions with h=2 hops and dilation ratio r=2 were used for the first and the last two layers of the encoder and the decoder respectively. We observed that by adding an additional convolution at the very end (of size equal to the size of the input feature space), training was accelerated. All of our activation functions were ELUs. Our learning rate was 10-3 with a decay of 0:99 after each epoch, and our weight decay was 5×10⁻⁵. All models were trained for 300 epochs.

4.3. Ablation Studies

4.3.1 Isotropic Vs Anisotropic Convolutions

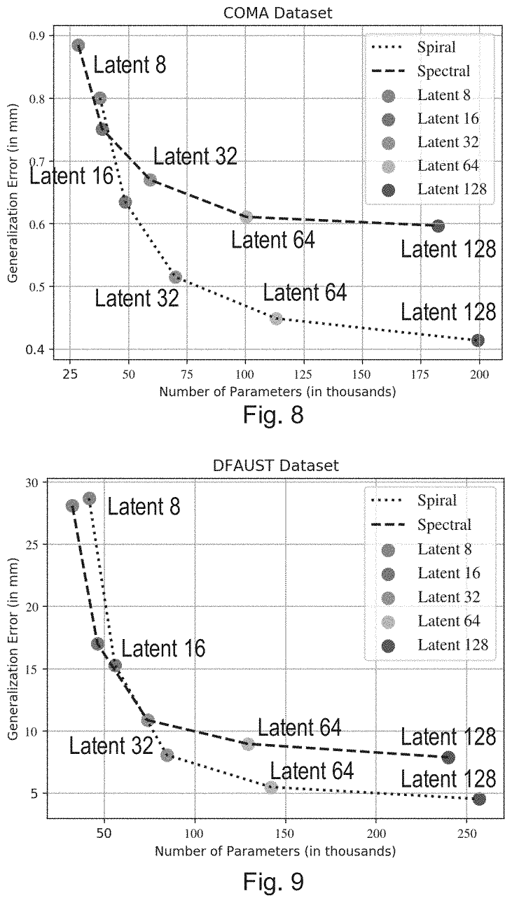

For the purposes of this experiment we used the architecture deployed by the authors of Ranjan et al. The number of parameters in our case is slightly larger due to the fact that the immediate neighbours, that affect the size of the spiral, range from 7 to 10, while the polynomials used in Ranjan et al. go up to the 6th power of the Laplacian. For both datasets, as clearly illustrated in FIGS. 8 and 9, spiral convolution-based autoencoders consistently outperform the spectral ones for every latent dimension, in accordance with the analysis made in section 3.1. Additionally, increasing the latent dimensions, our model's performance increases at a higher rate than its counterpart. Notice that the number of parameters scales the same way as the latent size grows, but the spiral model makes better use of the added parameters especially looking at dimensions 16, 32, 64, and 128. Especially on the COMA dataset, the spectral model seems to be flattening between 64 and 128 while the spiral is still noticeably decreasing.

4.3.2 Spiral vs Attention based Convolutions

In this experiment we compare our method with certain state-of-the-art soft-attention based Graph Neural Networks: MoNet: a patch-operator based model, where the attention weights are the learnable parameters of gaussian kernels defined on a pseudo-coordinate space (here we display the best obtained results when choosing the pseudocoordinates to be local cartesian), FeastNet and Graph Attention, where the attention weights are learnable functions of the input features.

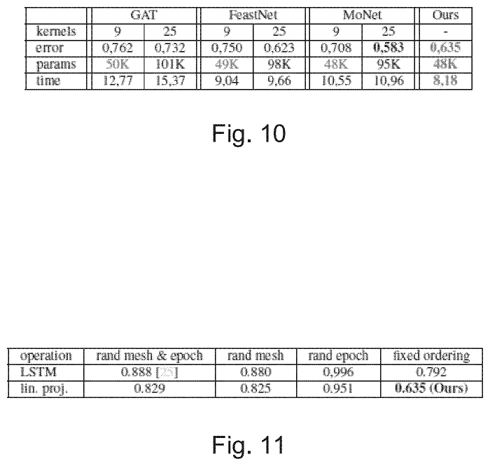

In FIG. 10, we provide results on COMA dataset, using the simple Neural3DMM architecture with latent size 16. We choose the number of attention heads (gaussian kernels) to be either 9 (equal to the size of the spiral in our method, for a fair comparison) or 25 (to showcase the effect of over-parametrisation). When it comes to similar number of parameters our method manages to outperform its counterparts, while compared to over-parametrised soft attention networks it either outperforms them, or achieves slightly worse performance. This shows that the spiral operator can make more efficient use of the available earnable parameters, thus being a lightweight alternative to attention-based methods without sacrificing performance. Also, its formulation may allow for fast computation; in FIG. 10 we measure per mesh inference time in ms (on a GeForce RTX 2080 Ti GPU).

4.3.3 Comparison to Lim et al.

In order to showcase how the operator behaves when the ordering is not consistent, we perform experiments under four scenarios: the original formulation of Lim et al., where each spiral is randomly oriented for every mesh and every epoch (rand mesh & epoch); choosing the same orientation across all the meshes randomly at every epoch (rand epoch); choosing different orientations for every mesh, but keeping them fixed across epochs (rand mesh); and fixed ordering (Ours). We compare the LSTM-based approach of Lim et al. and our linear projection formulation (Eq (2)). The experimental setting and architecture is the same as in the previous section. The proposed approach achieves over 28% improved performance compared to Lim et al., which substantiates the benefits of passing corresponding points through the same transformations.

4.4. Neural 3D Morphable Models

4.4.1 Quantitative Results

In this section, we compare the following methods for different dimensions of the latent space: PCA, the 3D Morphable Model, COMA, the ChebNet-based Mesh Autoencoder, Neural3DMM (small), ours spiral convolution autoencoder with the same architecture as in COMA, Neural3DMM (ours), our proposed Neural3DMM framework, where we enhanced our model with a larger parameter space (see Sec. 4.2). The latent sizes were chosen based on the variance explained by PCA (explained variance of roughly 85%, 95% and 99% of the total variance).

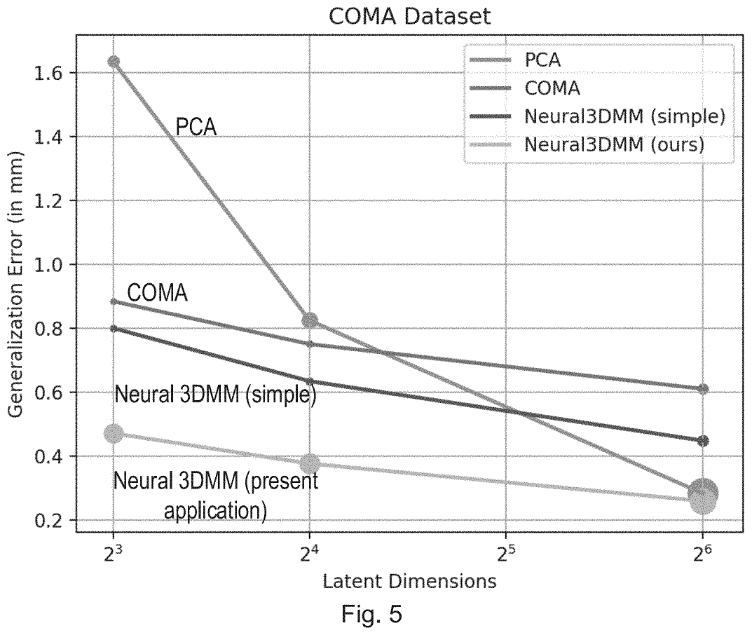

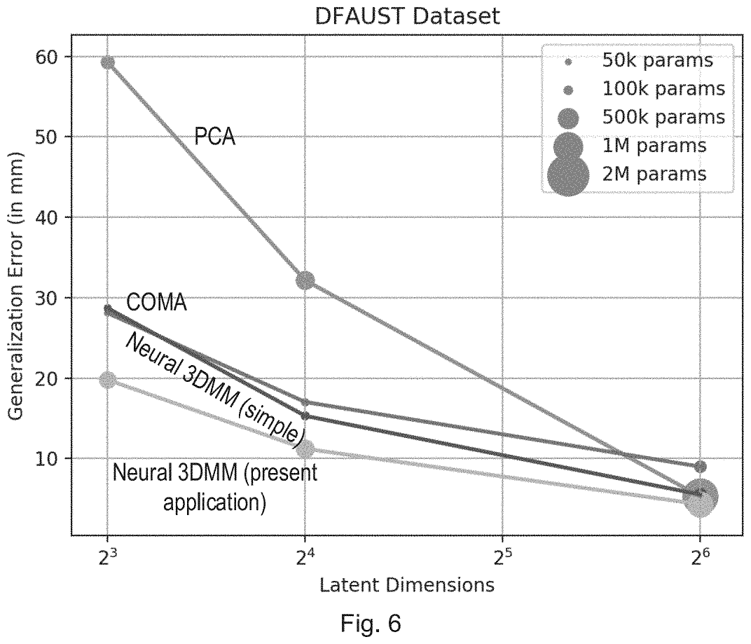

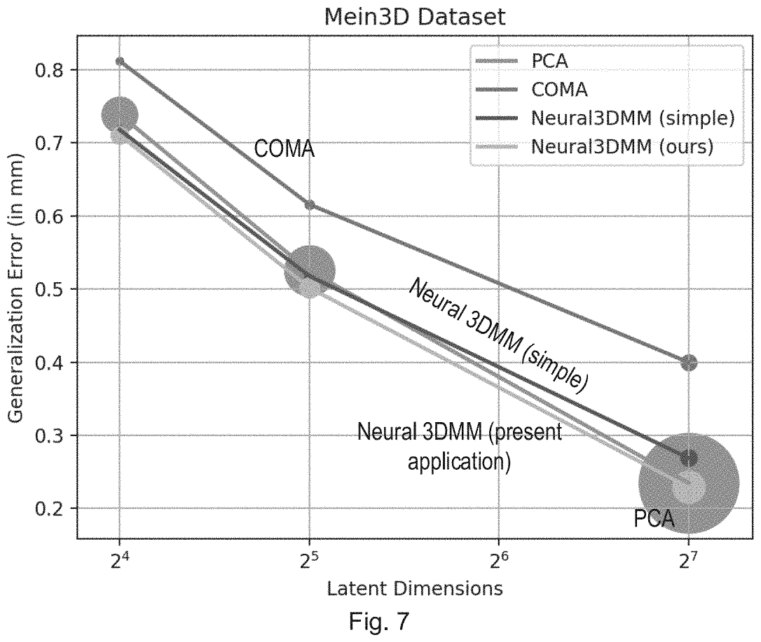

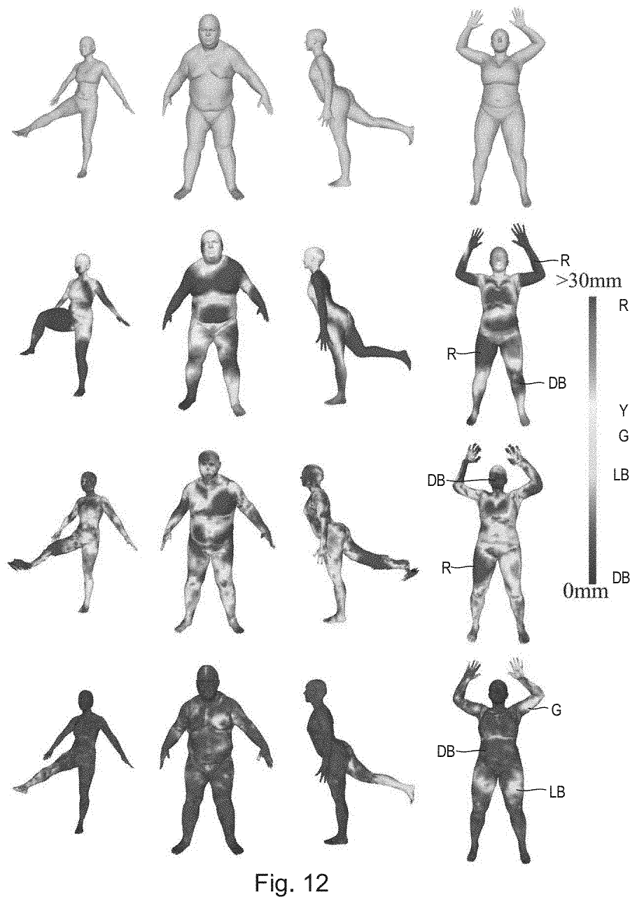

As can be seen from the graphs in FIGS. 5, 6 and 7, our Neural3DMM achieves smaller generalisation errors in every case it was tested on. For the COMA and DFAUST datasets all hierarchical intrinsic architectures outperform PCA for small latent sizes. That should probably be attributed to the fact that the localised filters used allow for effective reconstruction of smaller patches of the shape, such as arms and legs (for the DFAUST case), whilst PCA attempts a more global reconstruction, thus its error is distributed equally across the entire shape. This is well shown in FIG. 12, where we compare exemplar reconstructions of samples from the test set (latent size 16). It is clearly visible that PCA prioritises body shape over pose resulting to body parts in the wrong locations (for example see the right leg of the woman on the leftmost column). On the contrary COMA places the vertices in approximately correct locations, but struggles to recover the fine details of the shape leading to various artefacts and deformities; our model on the other hand seemingly balances these two difficult tasks resulting in quality reconstructions that preserve pose and shape.

Comparing to other methods, it is again apparent here that our spiral-based autoencoder has increased capacity, which together with the increased parameter space, makes our larger Neural3DMM outperform the other methods by a considerably large margin in terms of both generalisation and compression. Despite the fact that for higher dimensions, PCA can explain more than 99% of the total variance, thus making it a tough-to-beat baseline, our larger model still manages to outperform it. The main advantage here is the substantially smaller number of parameters of which we make use. This is clearly seen in the comparison for the MeIn3D dataset, where the large vertex count makes nonlocal methods as PCA impractical. It is necessary to mention here, that larger latent space sizes are not necessarily desirable for an autoencoder because they might lead to less semantically meaningful and discriminative representation for downstream tasks.

4.4.2 Qualitative Results

Here, we assess the representational power of our models by the common practice of testing their ability to perform linear algebra in their latent spaces.

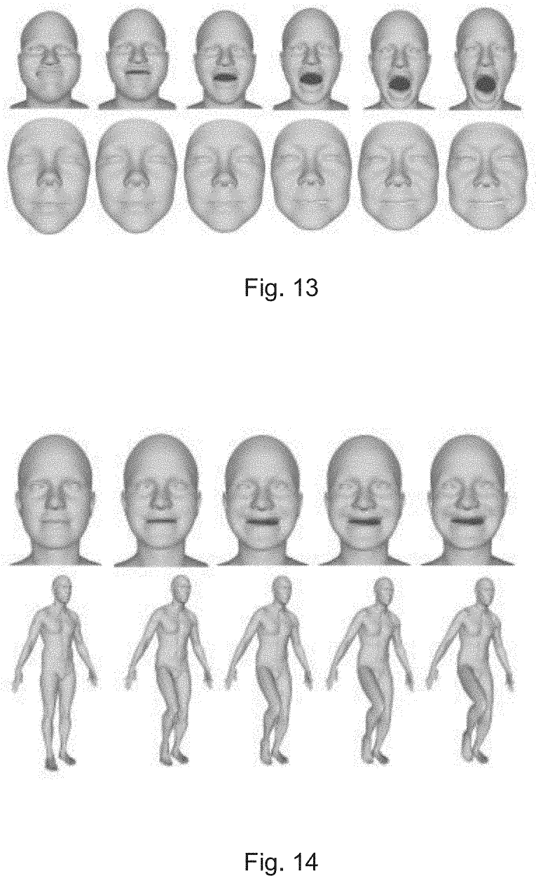

Interpolation FIG. 13: We choose two sufficiently different samples x₁ and x₂ from our test set, encode them in their latent representations z₁ and z₂ and then produce intermediate encodings by sampling the line that connects them i.e. z=azᵢ+(1−a)z₂, where a∈(0,1).

Extrapolation FIG. 14: Similarly, we decode latent representations that reside on the line defined by z₁ and z₂, but outside the respective line segment, i.e. z=a*z₁+(1−a)*z₂, where a∈(−∞, 0)∪(1, +∞). We choose z₁ to be our neutral expression for COMA and neutral pose for DFAUST, in order to showcase the exaggeration of a specific characteristic on the shape.

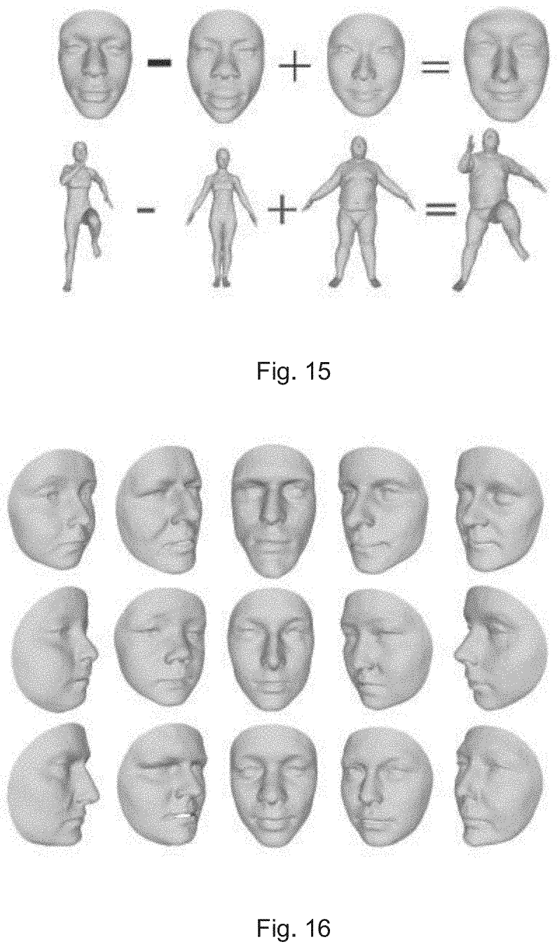

Shape Analogies FIG. 15: We choose three meshes A, B, C, and construct a D such that it satisfiesA:B::C:D using linear algebra in the latent space: e(B)−e(A)=e(D−e(C) e(*) the encoding), where we then solve for e(D) and decode it. This way we transfer a specific characteristic using meshes from our dataset.

4.5. GAN Evaluation

In FIG. 16, we sampled several faces from the latent distribution of the trained generator. Notice that they are realistically looking and, following the statistics of the dataset, span a large proportion of the real distribution of the human faces, in terms of ethnicity, gender and age. Compared to the most popular approach for synthesizing faces, i.e. the 3DMM, our model learns to produce fine details on the facial structure, making them hard to distinguish from real 3D scans, whereas the 3DMM, although it produces smooth surfaces, frequently makes it easy to tell the difference between real and artificially produced samples. We direct the reader to the supplementary material to compare with samples drawn from the 3DMM's latent space.

5. Conclusion

In this paper we introduced a representation learning and generative framework for fixed topology 3D deformable shapes, by using a mesh convolutional operator, spiral convolutions, that efficiently encodes the inductive bias of the fixed topology. We showcased the inherent representational power of the operator, as well as its reduced computational complexity, compared to prior work on graph convolutional operators and show that our mesh autoencoder achieves state-of-the-art results in mesh reconstruction. Finally, we present the generation capabilities of our models through vector space arithmetic, as well as by synthesising novel facial identities. Regarding future work, we plan to extend our framework to general graphs and 3D shapes of arbitrary topology, as well as to other domains that have capacity for an implicit ordering of their primitives, such as point clouds.

SpiralNet++: a Fast and Highly Efficient Mesh Convolution Operator

Intrinsic graph convolution operators with differentiable kernel functions play a crucial role in analyzing 3D shape meshes. In this paper, we present a fast and efficient intrinsic mesh convolution operator that does not rely on the intricate design of kernel function. We explicitly formulate the order of aggregating neighboring vertices, instead of learning weights between nodes, and then a fully connected layer follows to fuse local geometric structure information with vertex features. We provide extensive evidence showing that models based on this convolution operator are easier to train, and can efficiently learn invariant shape features. Specifically, we evaluate our method on three different types of tasks of dense shape correspondence, 3D facial expression classification, and 3D shape reconstruction, and show that it significantly outperforms state-of-the-art approaches while being significantly faster, without relying on shape descriptors. Our source code is available on GitHub.

1. Introduction

Geometric deep learning has led to a series of breakthroughs in a broad spectrum of problems ranging from biochemistry, physics to recommender systems. This method may allow computational models that are composed of multiple layers to learn representations of irregular data structures, such as graphs and meshes. The majority of current works focus on the study of generic graphs, whereas it is still challenging to extract non-linear low-dimensional features from manifolds. A path to ‘solving’ issues related to 3D computer vision then appears to be paved by defining intrinsic convolution operators. Attempts along this path started from formulating local intrinsic patches on meshes, and some other efforts exploit the similar idea of learning the filter weights between the nodes in a local graph neighbourhood with utilizing pre-defined local pseudo-coordinate systems over the graphs.

Driven by the significance of the design of kernel weight function, a few questions arise: Is designing better weight function the vital part of learning representations of manifolds? Can we find more efficient convolution operators without introducing elusive kernel functions and pseudocoordinates? It is somewhat intricate to answer if considering the problems defined on generic graphs with varied topologies. These problems, however, are possible to be addressed in terms of meshes, where data are generally aligned. In this paper, we address these problems by introducing a simple operator, called SpiralNet++, which captures local geometric structure from serializing the local neighbourhood of vertices. Instead of randomly generating sequences per epoch, SpiralNet++ generates spiral sequences only once in order to employ the prior knowledge of fixed meshes, which improves robustness. Since our approach explicitly encodes local information, the model is capable of efficiently learning discriminative features on 3D shapes. We further propose a dilated SpiralNet++ which may allow the leverage of neighborhoods at multiple scales to achieve detailed captures. SpiralNet++ is fast, efficient, and easy to apply to various tasks in the domain of 3D computer vision. In our experiments, we bring this operator into three types of challenging problems, i.e., dense shape correspondence, 3D facial expression classification, and 3D shape reconstruction. Without relying on pre-processed shape descriptors or pseudocoordinate systems, our approach outperforms the competitive baselines by a large margin in all the tasks.

2. Related Work

Geometric Deep Learning.

Geometric deep learning began with attempts to generalize convolutional neural networks for data with an underlying structure that is non-Euclidean. It has been widely adopted to the tasks of graphs and 3D geometry, such as node classification, community detection, molecule prediction, mesh deformation prediction, protein interaction prediction.

Dense Shape Correspondence.

We refer to related surveys on shape correspondence. Ovsjanikov et al. formulated a function correspondence problem to find a compact representation that could be used for pointto-point maps. Litany et al. took dense descriptor fields defined on two shapes as inputs and established a soft map between the two given objects, allowing end-to-end training. Masci et al. proposed to apply filters to local patches represented in geodesic polar coordinates. Boscaini et al. proposed the ACNN by using an anisotropic patch extraction method, exploiting the maximum curvature directions to orient patches. Monti et al. established a unified framework generalizing CNN architectures to non-Euclidean domains. Verma et al. proposed a graphconvolution operator of dynamic correspondence between filter weights and neighboring nodes with arbitrary connectivity, which is computed from features learned by the network. Lim et al. firstly proposed SpiralNet and applied it on this task, which achieved highly competitive results. However, we observe that because spiral sequences are randomly generated at each epoch, the model is hard to converge and normally requires a larger sequence length as well as high dimensional shape descriptors as input. In order to solve these issues, we present SpiralNet++ that overcomes all of these drawbacks.

3D Facial Expression Classification.

Facial expression recognition is a long-established computer vision problem with numerous datasets and methods having been proposed to address it. Cheng et al. proposed a high-resolution 4D facial expression dataset, 4DFAB, building a statistical learning model for static and dynamic expression recognition. In this paper, we are the first to introduce SpiralNet++ and other geometric deep learning methods into this task.

Shape Reconstruction.

Shape reconstruction is a task that recreates the surface or creates another crosssection. Ranjan et al. proposed a convolutional mesh autoencoder (CoMA) based on ChebyNet and spatial pooling to generate 3D facial meshes. Bouritsas et al. then integrated the idea of spiral convolution into mesh autoencoder based on the architecture of CoMA, called Neural3DMM. In contrast to SpiralNet, they manually selected a reference vertex on the template mesh and defined the spiral sequence based on the shortest geodesic distance from the reference vertex. We argue that it is actually unnecessary to calculate specific spirals but only introducing redundant procedures, since under the assumption of meshes having the same topology, the spirals are already fixed and the same across all the meshes once defined. Additionally, to allow fixed-size spirals for explicit k-disk, they do zero-padding for the vertices that have a smaller spiral length than the average length of k-disk. Intuitively, vertices with a shorter spiral sequence than the average would decrease training efficiency of the weights applied on the concatenated feature vectors, since non-negligible zero paddings always have them not updated. In this paper, our approach addresses these deficiencies and shows the state-of-the-art performance on this task.

3. Our Approach

We assume the input domain is represented as a manifold triangle mesh [symbol] =(V, [symbol] , [symbol] ), where V, [symbol] , [symbol] correspond to sets of vertices, edges and faces.

3.1. Main Concept

In contrast to previous approaches which aggregate neighboring node features based on trainable weight functions, our method encodes node features under a explicitly defined spiral sequence, and a fully connected layer follows to encode input features combined with ordering information. It is a simple yet efficient approach. In the following sections, we will elaborate on the definition of spiral sequence and the convolution operation in detail.

3.2. Spiral Sequence

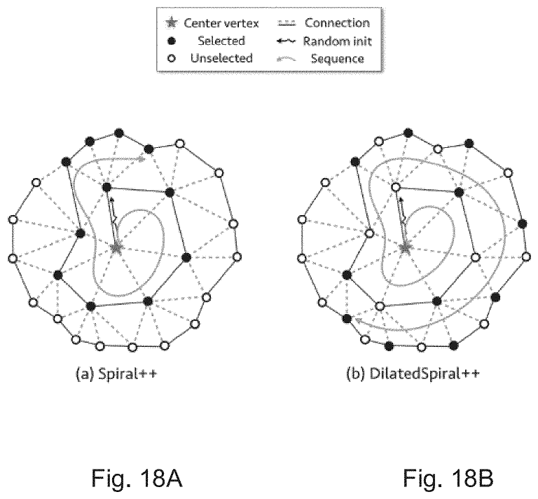

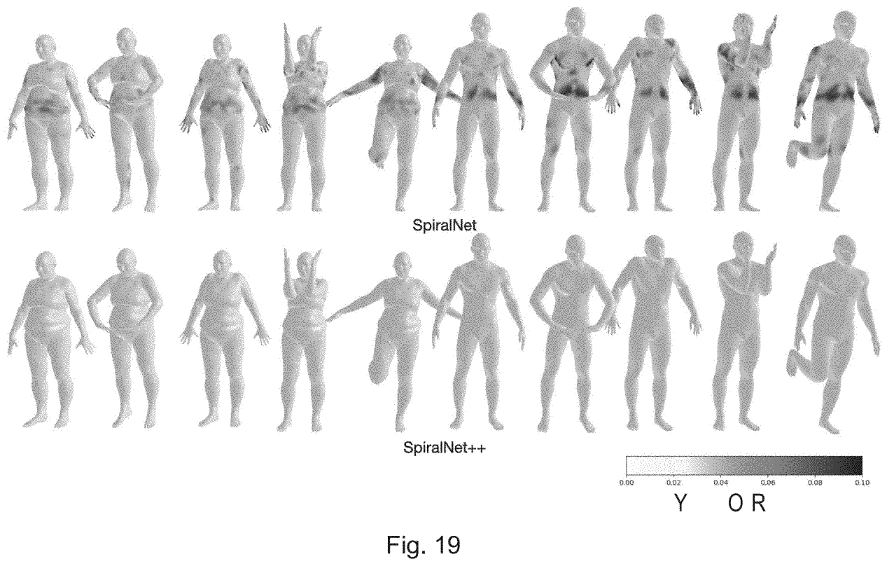

We begin with the definition of spiral sequences, which is the core step of our proposed operator. Given a center vertex, the sequence can be quite naturally enumerated by intuitively following a spiral, as illustrated in FIGS. 18A and 18B. The degrees of freedom are merely the orientation within each ring (clockwise or counter-clockwise) and the choice of the starting direction. We fix the orientation to counterclockwise here and choose an arbitrary starting direction. The spirals are pre-computed only once. We first define a k-ring and a k-disk around a center vertex v as follows:

0−ring(v)={v},

k−disk(v)=∪_{i=0, . . . k} i−ring(v),

(k+1)−ring(v)= [symbol] (v)\k−disk(v)

Where [symbol] (V) is the set of all vertices adjacent to any vertex in set V.

Here we denote the spiral length as l. Then S(v,l) is an ordered set consisting of l vertices from a concatenation of k-rings. Note that only part of the last ring will be concatenated to ensure a fixed-length serialization. We define it as follows:

S(v,l)⊂(0−ring(v),1−ring(v), . . . ,k−ring(v))

It shows remarkable advantages to allow the model to learn a high-level feature representation in terms of each vertex in a consistent and robust way when wefreeze spirals during training. Compared with SpiralNet, we credit the major improvement of our approach in terms of speed and efficiency to employing the nature of aligned meshes. Note that since we do not restrict spirals to the scope of a predefined number of rings, we are not involved in performance decays caused by introducing zero-padding. Furthermore, under the assumption of meshes having the same topology, the same vertex across meshes will always have the same spiral sequence regardless of the choice of starting direction, which eases the pain of manually defining the reference point and calculating the start point. By serializing the local neighborhood of vertices we are able to encode relevant information in a straightforward way with very little preprocessing.

3.3. Spiral Convolution

An euclidean CNN designs a two-dimensional kernel sliding on 2D images and maps D input feature maps to E output feature maps.

A common extension of CNNs into irregular domains, such as graphs, is typically expressed as a neighborhood aggregation or message passing scheme. With xᵢ^{(k-1)}∈ [symbol] ^{F} denoting node features of node i and e_{i,j}^{(k-1)}∈ [symbol] ^{D} denoting (optional) edge features from node i to node j in layer (k−1), message passing graph neural networks can be described as:

xᵢ^{(k)}−γ^{(k)}(xᵢ^{(k-1)}, [symbol] ϕ^{(k-1)},(xᵢ^{(k-1)},xⱼ^{(k-1)},e_{i,j}^{(k-1)}))

where xᵢ^{(k-1)}∈ [symbol] ^{F}′, and [symbol] denotes a differentiable permutation-invariant function, e.g., sum, mean or max, and ϕ denotes a differentiable kernel function. γ represents MLPs. In contrast to CNNs for regular inputs, where there is a clear one-to-one mapping, the main challenge in the case of irregular domains is to define the correspondence between neighbors and weight matrices which relies on the kernel function ϕ.

Thanks to the nature of the spiral serialization of neighboring nodes, we can define our spiral convolution in an equivalent manner to the euclidean CNNs, easing the pain of calculating the assignment value of xⱼ to the weight matrix. We define our spiral convolution operator for a node i as

$${x}_{i}^{( k )} = {γ}^{( k )} ( \begin{matrix}‖ \\ j ∈ {S ( i , l )}^{{X}_{j}^{( k - 1 )}}\end{matrix} )$$

where denotes MLPs and k is the concatenation operation. Note that we concatenate node features in the spiral sequence following the order defined in S(i; l).

Dilated Spiral Convolution.

With the motivation of exponentially expanding the receptive field without losing resolution or coverage, we define dilated spiral convolution operators. Obviously, spiral convolution operators could immediately gain the power of capturing multi-scale contexts without increasing complexity from uniformly sampling the spiral sequence while keeping the same spiral length, as illustrated in FIGS. 18A and 18B.

4. Experiments

In this section, we evaluate our method on three tasks, i.e., dense shape correspondence, 3D facial expression classification, and 3D shape reconstruction. We compare our method against FeaStNet, MoNet, ChebyNet and SpiralNet. To enable a fair comparison, the model architectures and the kernel size of different convolutions are the same and fixed, which yields the same level of parameterization. Furthermore, we use raw 3D coordinates as input node features instead of 3D shape descriptors as traditionally used for shape analysis. All the compared methods are with our implementation in order to enforce the same experimental setting except for Neural3DMM that we utilize their code directly. We train and evaluate each method on a single NVIDIA RTX 2080 Ti.

4.1. Dense Shape Correspondence

We validate our method on a collection of three-dimensional meshes solving the task of shape correspondence similar to previous studies. Shape correspondence refers to the task of labelling each node of a given shape to the corresponding node of a reference shape. We use the FAUST dataset, containing 10 scanned human shapes in 10 different poses, resulting in a total of 100 non-watertight meshes with 6,890 nodes each. The first 80 subjects in FAUST were used for training with the remaining 20 for testing.

Architectures and Parameters.

As for all the experiments, we follow the network architecture of. It consists of the following sequence of linear layers (1×1 convolutions) and graph convolutions: Lin(16)→Conv(32)→Conv(64)→Conv(128)→Lin(256)→Lin(6890),

where the numbers indicate the amount of output channels of each layer. A non-linear activation function, ELU (exponential linear unit), is used after each Conv and the first linear layer. The kernel size or spiral length of all the Convs is 10.

The models are trained with the standard cross-entropy classification loss. We take Adam as the optimizer with the learning rate of 3e−3 (SpiralNet++, MoNet, ChebyNet), 1e−3 (SpiralNet), 1e−2 (FeaStNet), and dropout probability 0.5. As for input features we use the raw 3D XYZ vertice coordinates instead of 544 dimensional SHOT descriptors which was previously used in MoNet, SpiralNet.

### Discussion

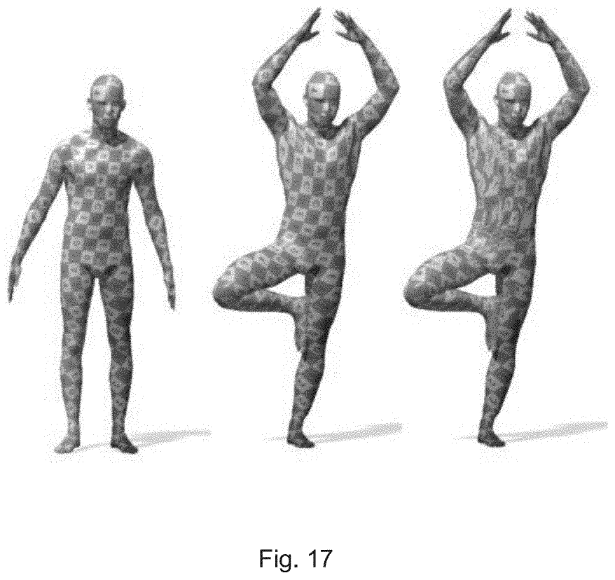

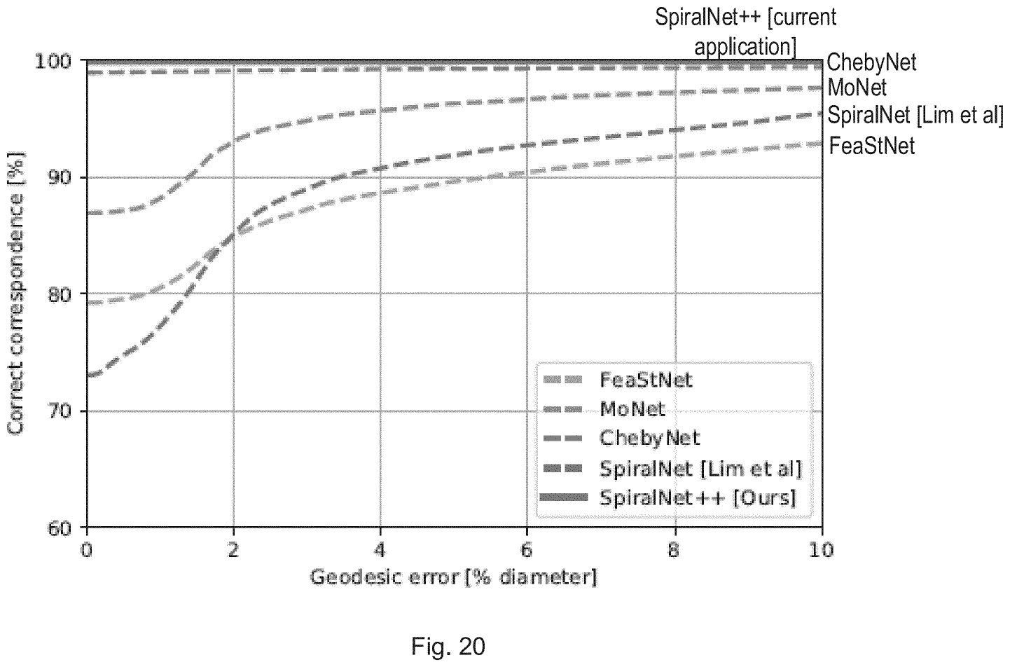

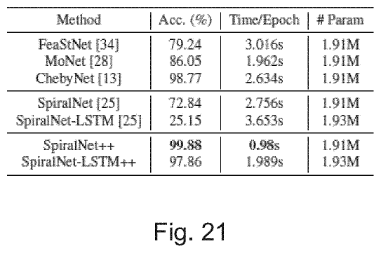

In FIG. 21, we present the accuracy of the exact correspondence (with 0% geodesic error) obtained by SpiralNet++ and other approaches. It shows that our method significantly outperforms all the baselines with 99.88% accuracy and its counterpart SpiralNet. It should be noted that our method enjoys an extremely fast speed with the training time of 0.98 s per epoch in average, which owes to our method exploiting the essence of the fixed mesh topologies. From experiments, we also observed that SpiralNet generally requires around 2500 epochs to converge while it is sufficient for SpiralNet++ to converge within 100 epochs. In FIG. 20, we plot the percentage of correspondences that are within a certain geodesic error. In FIG. 19, it can be seen that most nodes are classified correctly with our method, which is much better than Spiral-Net. FIG. 17 visualizes the obtained correspondence using texture transfer.

4.2.

3D Facial Expression Classification

As the second experiment, we address the problem of 3D facial expression classification using the 4DFAB dataset, which is a large scale dataset of high-resolution 3D faces. Previous efforts against this task focused on extracting low-dimensional features with PCA and LDA based on manually defined facial landmarks and a multi-class SVM was then employed to classify expressions. Similar to the deep convolutional neural networks used to classify the high-resolution images in the ImageNet, we develop an end-to-end hierarchical architecture with our method and other geometric deep learning approaches (e.g., ChebyConv, FeaStConv, MoNet) to solve this 3D mesh classification problem. Following the experimental setup introduced in Cheng et al. (Cheng et al. A large scale 4d database for facial expression analysis and biometric applications. In Proceedings of the IEEE conference on computer vision and pattern recognition, pages 5117-5126, 2018.), we partition the data into 10 folds, and 17 distinct participants in testset are not shown in trainset (with 153 distinct participants). The number of each class is balanced in both training set and test set.

Pooling.

The models use a mesh pooling operation based on edge contraction. The pooling operation iteratively contracts vertex pairs to simplify meshes, while maintaining surface error approximation using quadric metrics. The output feature is then directly obtained by the multiplication of input feature with a downsampling transform matrix. We denote a pooling layer using this algorithm with Pool(c), with c being the downsampling factor.

Architectures and Parameters.

We design the following end-to-end architecture to classify 3D facial expressions:

Conv(16)→Pool(4)→Conv(16)→Pool(4)→FC(32)→FC(6).

Dropout with a probability of 0.5 is used before each FC layer. We take a standard cross entropy loss function and ELU activation function. Training is done for 300 epochs with the learning rate of 1e−3, learning rate decay of 0.99 per epoch, L2 regularization of 5e−4, batch size of 32.

It should be noted that raw 3D XYZ coordinates are used as the input, and for MoNet, we use the relative Cartesian coordinates of linked nodes as its pseudo-coordinates. Furthermore, we fixed the same hyperparameters (i.e., kernel size, spiral sequence length or order of the polynomial K) for each convolution, which gives the same size of parameter space of [symbol] ^{K×C}^{ᵢₙ}^{×C}^{ₒᵤₜ} in terms of each convolution layer.

### Discussion

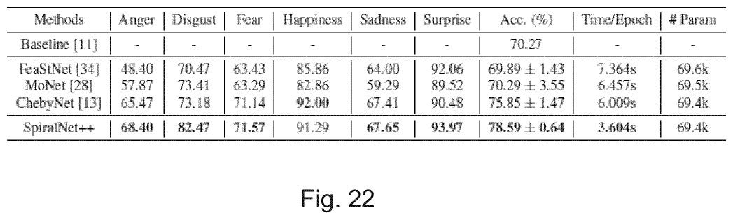

All results of the 3D facial expression classification are shown in FIG. 22. It shows that with our proposed architecture, all of the graph convolution operations outperform the baseline. We credit these improvements to the capacity of learning intrinsic shape features compared to the baseline method. Specifically, our method achieves the highest recognition rate of 78.59% on average. This indicates that SpiralNet++ can be successfully applied to multiscale mesh data improving previous results in this domain. Furthermore, it can be seen that our method is much more faster than all the other approaches.

4.3. 3D Shape Reconstruction

As our largest experiment, we evaluate the effectiveness of SpiralNet++ on an extreme facial expression dataset. We demonstrate that a standard autoencoder architecture with SpiralNet++ may allow the synthesis of high-fidelity 3D face with rich expression details. We use a dataset which consists of 12 classes of extreme expressions, containing over 20,4653D meshes, each with about 5,023 vertices and 14,995 edges. Following the interpolation experimental setup, we divide the dataset into training and test sets with a split ratio of 9:1. We compare our SpiralNet++ against a number of baselines including CoMA and Neural3DMM, and furthermore, for the first time, we bring MoNet and FeaStNet into this problem to explore the performance of other intrinsic convolution operations on generative models. It is worth highlighting that in the original work of CoMA, they used ChebyNet with K=6. However, in order to have a fair comparison with other experiments, we show both results obtained with K=6 (i.e., CoMA) and K=9. In the end, we evaluate our proposed dilated spiral convolution on this problem.

Pooling and Unpooling.

The performance of each generative model is closely related to the pooling and unpooling procedures. The same pooling strategy introduced in Section 4.2 is used here. In the unpooling stage, contracted vertices are recovered using the barycentric coordinates of the closet triangle in the decimated mesh.

Architectures and Parameters.

We build a standard autoencoder architecture, consisting of an encoder and a decoder. The encoder includes several convolutional layers interleaved between pooling layers, and one fully connected layer is applied in the end of the encoder to encode nonlinear mesh representations. Specifically, the structure is:

3×{Conv(32)→Pool(4)}→{Conv(64)→Pool(4)}→FC(16),

with ELU activation function after each Conv layer. The structure of the decoder is the reversed order of the encoder with the replacement of pooling layers to unpooling layers. Note that one more convolutional layer with the output dimensional of 3 should be added to the end of the decoder to reconstruct 3D shape coordinates. Training is done using Adam for 300 epochs with learning rate of 0.001, learning rate decay of 0.99 per epoch and a batch size of 32.

We evaluate all the methods with the same architecture and hyperparameters. The kernel size of each methods is set as 9 in order to keep aligned with Neural3DMM, where they chose 1-hop deriving the spiral length of 9.

Discussion

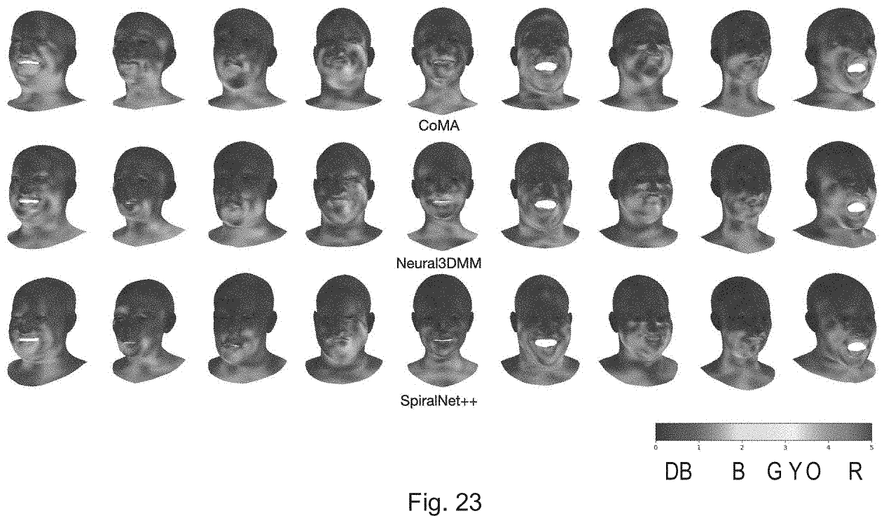

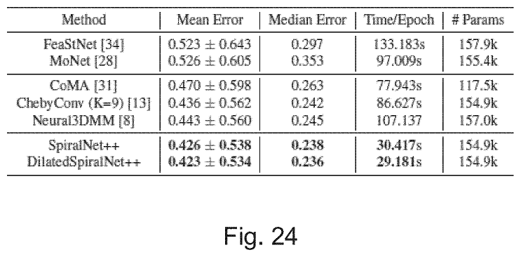

FIG. 24 shows mean euclidean errors with standard deviations, median errors and the training time per epoch. Our SpiralNet++ and its dilated version outperform all the other approaches. The result of our proposed dilated spiral convolution validates our assumption, which shows the higher capacity of capturing non-linear low-dimensional representations of 3D shape meshes without increasing parameters. We credit this improvement to its larger receptive field brought by sampling larger input feature space. Moreover, we should stress the remarkable speed of our method. With the same autoencoder architecture, SpiralNet++ is a few times faster than all the other methods. It should be noted that the performance of Neural3DMM is even worse than CoMA when bring weight matrices to the same number, which can be attributed to the fact that model learning is disrupted from introducing non-negligible information (i.e., zero-padding). The performance of Neural3DMM would decrease with the variance of vertex degrees increase. FIG. 23 shows the visualization of reconstructed faces in the test set. Larger errors can be seen from the faces generated by CoMA and Neural3DMM, and in particular, it become worse on the faces with extreme expressions. However, SpiralNet++ shows better reconstruction quality in these cases.

5. Conclusions

We explicitly introduce SpiralNet++ to the domain of 3D shape meshes, where data are generally aligned instead of varied topologies, which may allow SpiralNet++ to efficiently fuse neighboring node features with local geometric structure information. We further apply this method to the tasks of dense shape correspondence, 3D facial expression classification and 3D shape reconstruction. Extensive experimental results show that our approach are faster and outperform competitive baselines in all the tasks.

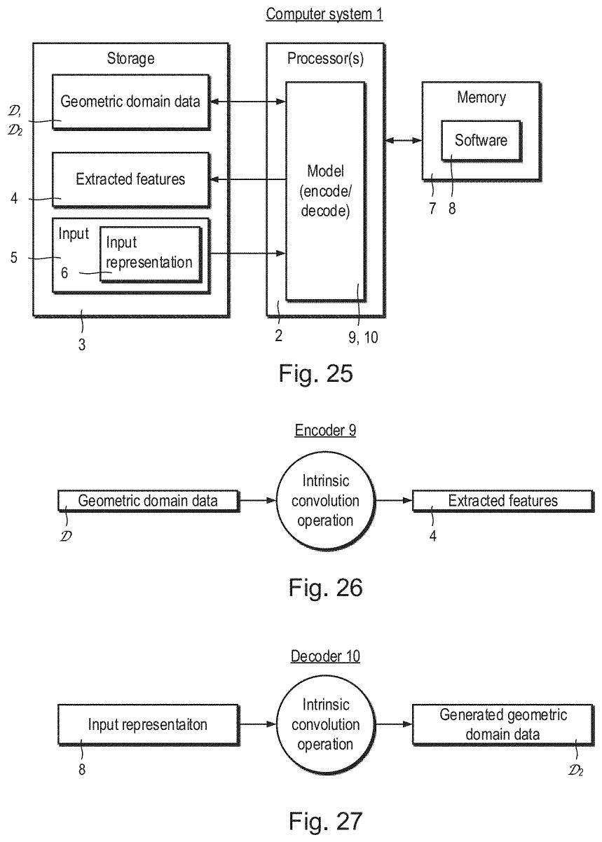

Referring to FIG. 25, a computer system 1 includes at least one processor 2, a storage 3 for storing the geometric domain data [symbol] and the extracted features 4 and/or an input 5 including and input representation 6. The computer system 1 further includes memory 7 which includes software 8 for running the encoding and decoding models 9, 10, or certain steps of those models. The models 9, 10 are run by the processor 2. The processor 2 may be a central processing unit, or a graphics processing unit. The processor 2 may have one or more cores.

Referring to FIG. 26, when the system 1 is running as an encoder 9, the processor 2 receives the geometric domain data [symbol] , applies an intrinsic convolutional layer to the data [symbol] and generates a set of extracted features 4 which are a representation of the geometric domain data [symbol] by applying at least an intrinsic convolution layer 12 on the geometric domain data [symbol] . The intrinsic convolutional layer includes a consistent local ordering of data points on the geometric domain.

Referring to FIG. 27, when the system 1 is running as a decoder 10, the processor receives an input 5 which includes at least an input representation 6. The processor then decodes the input representation 6, and generates an output geometric domain [symbol] ₂ by applying at least an intrinsic convolution layer 12 on the input representation 6. The intrinsic convolutional layer includes a consistent local ordering of data points on the geometric domain.

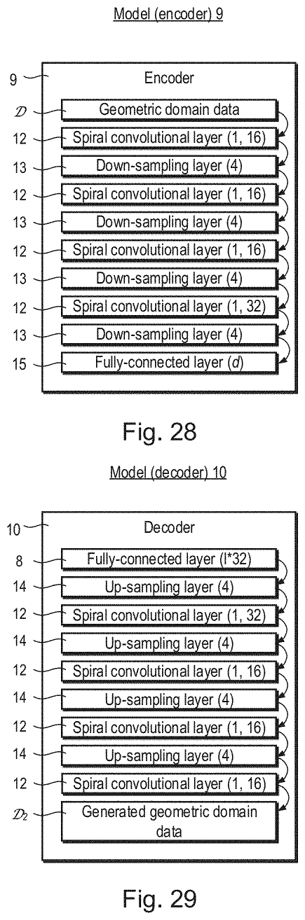

Referring to FIGS. 28 and 29, the encoder 9 and the decoder 10 may also include applying down-sampling layers 13 (for the encoder) or upsampling layer 14 (for the decoder) between the application of convolutional layers 12. The encoder may generate a fully connected layer 15. The input representation 8 may be a fully connected layer 15.

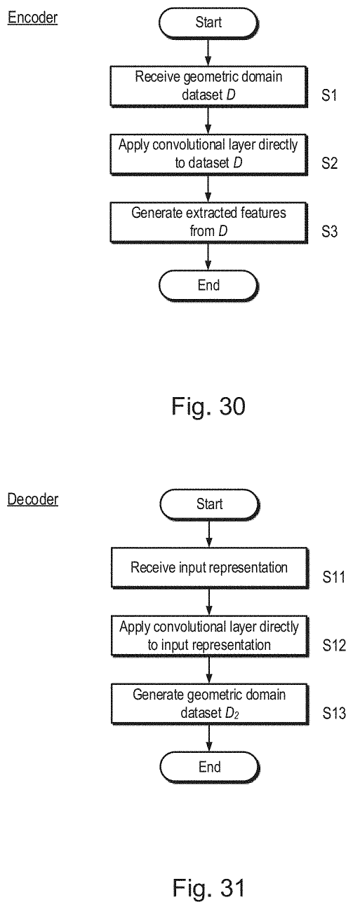

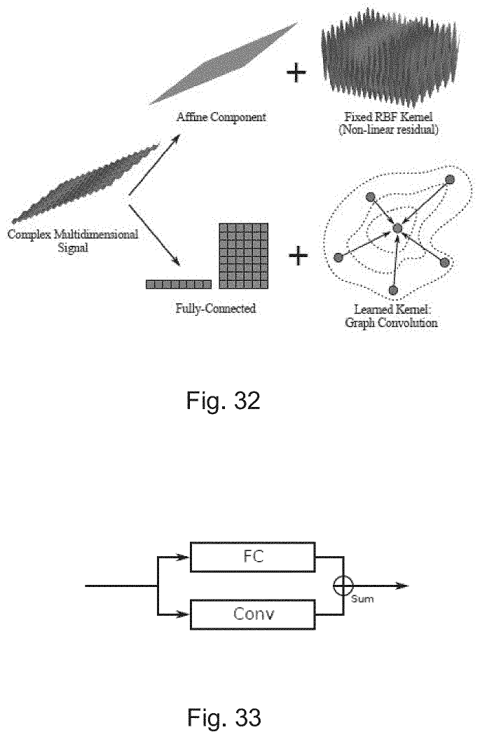

Referring to FIG. 30, the encoder 9 receives the geometric domain data (S1), applies the convolutional later directly to the geometric domain dataset (S2) and generates extracted features from that data set (S3).

Referring to FIG. 31, the decoder 10 receives an input including an input representation (S11), applies a convolutional layer directly to the input representation (S12) and generates a geometric domain dataset (S13).

Geometrically Principled Connections in Graph Neural Networks

Graph convolution operators bring the advantages of deep learning to a variety of graph and mesh processing tasks previously deemed out of reach. With their continued success comes the desire to design more powerful architectures, often by adapting existing deep learning techniques to non-Euclidean data. In this paper, we argue geometry should remain the primary driving force behind innovation in the emerging field of geometric deep learning. We relate graph neural networks to widely successful computer graphics and data approximation models: radial basis functions (RBFs). We conjecture that, like RBFs, graph convolution layers would benefit from the addition of simple functions to the powerful convolution kernels. We introduce affine skip connections, a novel building block formed by combining a fully connected layer with any graph convolution operator. We experimentally demonstrate the effectiveness of our technique, and show the improved performance is the consequence of more than the increased number of parameters. Operators equipped with the affine skip connection markedly outperform their base performance on every task we evaluated, i.e., shape reconstruction, dense shape correspondence, and graph classification. We hope our simple and effective approach will serve as a solid baseline and help ease future research in graph neural networks.

1. Introduction

The graph formalism has established itself as the lingua franca of non-Euclidean deep learning, as graphs provide a powerful abstraction for very general systems of interactions. In the same way that classical deep learning developed around the Convolutional Neural Networks (CNNs) and their ability to capture patterns on grids by exploiting local correlation and to build hierarchical representations by stacking multiple convolutional layers, most of the work on graph neural networks (GNNs) has focused on the formulation of convolution-like local operators on graphs.

In computer vision and graphics, early attempts at applying deep learning to 3D shapes were based on dense voxel representations or multiple planar views. These methods suffer from three main drawbacks, stemming from their extrinsic nature: high computational cost of 3D convolutional filters, lack of invariance to rigid motions or non-rigid deformations, and loss of detail due to rasterisation.

A more efficient way of representing 3D shapes is modelling them as surfaces (two-dimensional manifolds). In computer graphics and geometry processing, a popular type of efficient and accurate discretisation of surfaces are meshes or simplicial complexes, which can be considered as graphs with additional structure (faces). Geometric deep learning seeks to formulate intrinsic analogies of convolutions on meshes accounting for these structures.

As a range of effective graph and mesh convolution operators are now available, the attention of the community is turning to improving the basic GNN architectures used in graph and mesh processing to match those used in computer vision. Borrowing from the existing literature, extensions of successful techniques such as residual connections and dilated convolutions have been proposed, some with major impact in accuracy. We argue, however, that due to the particularities of meshes and to their non-Euclidean nature, geometry should be the foundation for architectural innovations in geometric deep learning.

Contributions

In this application, we provide a new perspective on the problem of deep learning on meshes by relating graph neural networks to Radial Basis Function (RBF) networks. Motivated by fundamental results in approximation, we introduce geometrically principled connections for graph neural networks, coined as affine skip connections, and inspired by thin plate splines. The resulting block learns the sum of any existing graph convolution operator and an affine function, allowing the network to learn certain transformations more efficiently. Through extensive experiments, we show our technique is widely applicable and highly effective. We verify affine skip connections improve performance on shape reconstruction, vertex classification, and graph classification tasks. In doing so, we achieve best in class performance on all three benchmarks. We also show the improvement in performance is significantly higher than that provided by residual connections, and verify the connections improve representation power beyond a mere increase in trainable parameters. Visualizing what affine skip connections learn further bolsters our theoretical motivation.

Notations

Throughout the paper, matrices and vectors are denoted by upper and lowercase bold letters (e.g., X and (x), respectively. I denotes the identity matrix of compatible dimensions. The i^{th} column of X denoted as xᵢ. The sets of real numbers is denoted by [symbol] . A graph [symbol] =(V, [symbol] ) consists of vertices V={1, . . . , n} and edges [symbol] ⊆V×V. The graph structure can be encoded in the adjacency matrix A, where aᵢⱼ=1 if (i)∈ [symbol] (in which case i and j are said to be adjacent) and zero otherwise. The degree matrix D is a diagonal matrix with elements dᵢᵢ=Σⱼ₌₁ⁿaᵢⱼ. The neighborhood of vertex i, denoted by [symbol] (i)={j: (i,j)∈ [symbol] }, is the set of vertices adjacent to i.

2. Related work

Graph and mesh convolutions The first work on deep learning on meshes mapped local surface patches to precomputed geodesic polar coordinates; convolution was performed by multiplying the geodesic patches by learnable filters. The key advantage of such an architecture is that it is intrinsic by construction, affording it invariance to isometric mesh deformations, a significant advantage when dealing with deformable shapes. MoNet generalized the approach using a local system of pseudo-coordinates uᵢⱼ to represent the neighborhood [symbol] (i) and a family of learnable weighting functions w.r.t. u, e.g., Gaussian kernels wₘ(u)=exp(−½u−μₘ)^{T} Σₖ⁻¹(u−μₘ)) with learnable mean μₘ and covariance Σₘ. The convolution is

$${x}_{i}^{( k )} = {\sum }_{m = 1}^{M} {θ}_{m} {\sum }_{j ∈ ( i )} {w}_{m} ( {u}_{ij} ) {x}_{j}^{( k - 1 )} \qquad ( 1 )$$

where xᵢ^{(k-1)} and xᵢ^{(k)}) denotes the input and output features at vertex i, respectively, and is the vector of learnable filter weights. MoNet can be seen as a Gaussian Mixture Model (GMM), and as a more general form of the Graph Attention (GAT) model. Local coordinates were re-used in the Spline Convolutional Network, which represents the filters in a basis of smooth spline functions. Another popular attention-based operator is FeaStNet, that learns a soft mapping from vertices to filter weights, and has been applied to discriminative and generative models:

$${x}_{j}^{( k )} = b + \frac{1}{\vert ( i ) \vert} {\sum }_{m = 1}^{M} {\sum }_{j ∈ ( i )} {q}_{m} ( {x}_{i}^{( k - 1 )} , {x}_{j}^{( k - 1 )} ) {W}_{m} {x}_{j}^{( k - 1 )} \qquad ( 2 )$$

where Wm a matrix of learnable filters weights for the m-th filter, qₘ is a learned soft-assignment of neighbors to filter weights, and b the learned bias of the layer. It is tacitly assumed here that i∈ [symbol] (i)

ChebNet accelerates spectral convolutions by expanding the filters on the powers of the graph Laplacian using Chebychev polynomials. Throughout this paper, we will refer to the n-order expansion as ChebNet-n. in particular the first order expansion ChebNet-1 reads

$${X}^{( k )} = - {D}^{- \frac{1}{2}} {AD}^{- \frac{1}{2}} {X}^{( k - 1 )} {Θ}_{1} + {X}^{( k - 1 )} {Θ}_{0} \qquad ( 3 )$$

with

$$L = - {D}^{- \frac{1}{2}} A {D}^{- \frac{1}{2}}$$

the normalised symmetric graph Laplacian, A is the graph adjacency matrix, and D is the degree matrix. In computer graphics applications, ChebNet has seen some success in mesh reconstruction and generation. However, due to the fact that spectral filter coefficients are basis dependent, the spectral construction is limited to a single domain. We therefore do not evaluate the performance of ChebNet on correspondence tasks. We refer to Kovantsky et al. (Artiom Kovnatsky, Michael M Bronstein, Alexander M Bronstein, Klaus Glashoff, and Ron Kimmel. Coupled uasiharmonic bases. In Computer Graphics Forum, volume 32, pages 439-448. Wiley Online Library, 2013) and Eynard et al. (Davide Eynard, Artiom Kovnatsky, Michael M Bronstein, Klaus Glashoff, and Alexander M Bronstein. Multimodal manifold analysis by simultaneous diagonalization of laplacians. IEEE transactions on pattern analysis and machine intelligence, 37(12):2505-2517, 2015) 2015 for constructing compatible orthogonal bases across different domains. The Graph Convolutional Network (GCN) model further simplifies (3) by considering first-order polynomials with dependent coefficients, resulting in

X₍ₖ₎=LX^{(k-}1)Θ. (4)

where

$$\tilde{L} = {\tilde{D}}^{\frac{1}{2}} \tilde{A} {\tilde{D}}^{- \frac{1}{2}} = I + {D}^{- \frac{1}{2}} {AD}^{- \frac{1}{2}} .$$

By virtue of this construction, GCN introduces self-loops. GCN is perhaps the simplest graph neural network model combining vertex-wise feature transformation (right-side multiplication by Θ) and graph propagation (left-side multiplication by L). For this reason, it is often a popular baseline choice in the literature, but it has never applied successfully on meshes. Recently, models based on the simple consistent enumeration of a vertex's neighbors have emerged. SpiralNet enumerates the neighbors around a vertex in a spiral order and learns filters on the resulting sequence with a neural network (MLP or LSTM). The recent SpiralNet++ improves on the original model by enforcing a fixed order to exploit prior information about the meshes in the common case of datasets of meshes that have the same topology. The SpiralNet++ operator is written xᵢ^{(k)}=γ^{(k)}(∥_{j∈S(i,M)}xⱼ^{(k-1)} with γ^{(k)} an MLP, ∥ the concatenation, and S(i,M) the spiral sequence of neighbors of i of length (i.e. kernel size) M.

Finally, we include the recently proposed Graph Isomorphism Network (GIN) [52] with the update formula

$${x}_{i}^{( k )} = {γ}^{( k )} ( ( 1 + {ϵ}^{( k )} ) \cdot {x}_{i}^{( k - 1 )} + {\sum }_{j ∈ ( i )} {x}_{j}^{( k - 1 )} ) . \qquad ( 5 )$$

This model is designed for graph classification and was shown [52] to be as powerful as the Weisfeiler-Lehman graph isomorphism test.

Skip connections and GNNs Highway Networks present shortcut connections with data-dependent gating functions, which are amongst the first architectures that provided a means to effectively train deep networks. However, highway networks have not demonstrated improved performance due to the fact that the layers in highway networks act as non-residual functions when a gated shortcut is “closed”. Concurrent with this work, pure identity mapping made possible the training of very deep neural networks, and enabled breakthrough performance on many challenging image recognition, localization, and detection tasks. They improve gradient flow and alleviate the vanishing gradient problem. DenseNets can be seen as a generalization of and connect all layers together. Early forms of skip connections in GNNs actually predate the deep learning explosion and can be traced back to the Neural Network for Graphs (NN4G) model, where the input of any layer is the output of the previous layer plus a function of the vertex features. We refer to Li et al. (Guohao Li, Matthias Muller, Ali Thabet, and Bernard Ghanem. DeepGCNs: Can GCNs Go As Deep As CNNs? In The IEEE International Conference on Computer Vision (ICCV), 2019), section 2.1 for a summary of subsequent approaches). In, the authors propose direct graph equivalents for residual connections and dense connections, provide an extensive study of their methods, and show major improvements in the performance of the DGCNN architecture with very deep models.

3. Motivation: Radial Basis Interpolation

The main motivation of this paper comes from the field of data interpolation. Interpolation problems appear in many machine learning and computer vision tasks. In the general setting of scattered data interpolation, we seek a function \hat{ƒ} whose outputs \hat{ƒ}(xᵢ) on a set of scattered data points xᵢ equals matching observations yᵢ, i.e., ∀i, ƒ(xᵢ)=yᵢ. In the presence of noise, one typically solves an approximation problem potentially involving regularization, i.e.

$${min}_{f} {\sum }_{i} d ( \hat{f} ( {x}_{i} ) , {y}_{i} ) + λ L ( \hat{f} ) , \qquad ( 6 )$$

where d measures the adequation of the model \hat{ƒ} to the observations, λ is a regularization weight, and L encourages some chosen properties of the model. For the sake of the discussion, we take d(x,y)=∥Z−y∥. In computer graphics, surface reconstruction and deformation (e.g. for registration) can be phrased as interpolation problems. In this section, we draw connections between graph convolutional networks and a classical popular choice of interpolants: Radial Basis Functions (RBFs).

Radial basis functions An RBF is a function of the form x x [symbol] ϕ(∥x−cᵢ∥), with ∥.∥ a norm, and ci some pre-defined centers. By construction, the value of an RBF only depends on the distance from the centers. While an RBF function's input is scalar, the function can be vector-valued. In interpolation problems, the centers are chosen to be the data points (cᵢ=xᵢ) and the interpolant is defined as a weighted sum of radial basis functions centered at each xᵢ:

$$\hat{f} ( x ) = {\sum }_{i = 1}^{N} {w}_{i} ϕ ( ‖ x - {x}_{i} ‖ ) . \qquad ( 7 )$$

Interpolation assumes equality, so the problem boils down to solving the linear system Φwᵢ=bⱼ with Φᵢⱼ=ϕ(|xᵢ−xⱼ∥) the matrix of the RBF kernel (note that the diagonal is −(0) 8i). The kernel matrix encodes the relationships between the points, as measured by the kernel. Relaxing the equality constraints can be necessary, in which case we solve the system in the least squares sense with additional regularization. We will develop this point further to introduce our proposed affine skip connections.

Relations to GNNs An RBF function can be seen as a simple kind of one layer neural network with RBF activations centered around every points (i.e. an RBF network). The connection to graph neural networks is very clear: while the RBF matrix encodes the relationships and defines a point's neighborhood radially around the point, graph neural networks rely on the graph connectivity to hard-code spatial relationships. In the case of meshes, this encoding is all-themore relevant, as a notion of distance is provided either by the ambient space (the graph is embedded) or directly on the Riemannian manifold. The latter relates to the RBFs with geodesic distance of Rhee et al. (Taehyun Rhee, Youngkyoo Hwang, James Dokyoon Kim, and Changyeong Kim. Real-time facial animation from live video tracking. In Proceedings—SCA 2011: ACM SIGGRAPH/Eurographics Symposium on Computer Animation, 201).

Most GNNs used on meshes fall into the message passing framework:

$${x}_{i}^{( k )} = {γ}^{( k )} ( {x}_{i}^{( k - 1 )} , {•}_{j ∈ ( i )} {ϕ}^{( k )} ( {x}_{i}^{( k - 1 )} , {x}_{j}^{( k - 1 )} , {e}_{ij}^{( k - 1 )} ) ) , \qquad ( 8 )$$

where □ denotes a differentiable permutation-invariant function, (e.g. max or Σ), ϕ differentiable kernel function, is an MLP, and xᵢ and eᵢⱼ are features associated with vertex i and edge (i,j), respectively. This equation defines a compactly supported, and possibly non-linear, function around the vertex. For the MoNet equation (1) the connection to RBFs is direct. Contrary to RBFs, the filters of modern GNNs do not have to be radial. In fact, anisotropic filters have been shown to perform better than isotropic ones. The other major differences are:

1. The filters are learned functions, not pre-defined; this may allow for better inductive learning and task-specificity

2. The filters apply to any vertex and edge features

3. Some operators support self-loops, but diag(Φ)=<ϕ(0) irrespective of the features xᵢ

We note that the compact support of is a design decision: early GNNs built on the graph Fourier transform lacked compactly-supported filters. In RBF interpolation, global support is sometimes desired as it is a necessary condition for maximal fairness of the interpolated surfaces (i.e. maximally smooth), but also induces computational complexity and numerical challenges as the dense kernel matrices grow and become ill-conditioned. This motivated the development of fast methods to fit locally supported RBFs. It has previously been argued that compactly-supported kernels are desirable in graph neural networks for computational efficiency, and to promote learning local patterns. This especially justified for meshes, for which the graph structure is very sparse. Additionally, stacking convolutional layers is known to increase the receptive field, including in graph neural networks. The composition of locally supported filters can therefore yield globally supported mappings.

RBFs and polynomials. A common practice with RBFs is to add low-order polynomial terms to the interpolant:

$$\hat{f} ( x ) = {\sum }_{i = 1}^{N} {w}_{i} ϕ ( ‖ x - {x}_{i} ‖ ) + P ( x ) . \qquad ( 9 )$$

The practical motivation is to ensure polynomial mappings of some order can be represented exactly and to avoid unwanted oscillations when approximating flat functions, e.g. affine transformations of an image should be exactly affine. One can show this is equivalent to ensuring the RBF weights lie in the null space of the polynomial basis, also known as the vanishing moments condition.

However, polynomials appear organically when the RBF kernel is derived to be optimal for a chosen roughness measure, typically expressed in terms of the integral of a squared differential operator D (below in one dimension):

∥Df∥²=∫|Df(x)|²|dx, (10)

e.g.,

$$D = \frac{{d}^{2}}{{dx}^{2}}$$

In other words, when the kernel is sought to be optimal for a given regularization functional. Differential operators are very naturally expressed on meshes in terms of finite difference approximations. In this case, we identify D with its corresponding stencil matrix. The interpolation problem becomes the minimization of (10) subject to the interpolation constraints.

It can be shown that for such problems the RBF kernel is the Green's function of the squared differential operator, and that for an operator of order m, polynomials of order m−1 span the null space. Therefore, the complete solution space is the direct sum (Hence the vanishing moment condition) of the space of polynomials of order m−1 (the null space of the operator) and the space spanned by the RBF kernel basis (This result comes from phrasing the problem as regularization in a Reproducing Kernel Hilbert Space. To keep the discussion short in this manuscript, we refer the reader to relevant resources.

Thin Plate Splines (TPS) An important special case is the RBF interpolant for a surface z(x), x=[x y]^{T} that minimizes the bending energy

$$\int \int \frac{{\partial }^{2} f}{\partial {x}^{2}} + \frac{{\partial }^{2} f}{\partial x \partial y} + \frac{{\partial }^{2} f}{\partial {y}^{2}} \partial x \partial y = ‖ {Δ}^{2} f ‖ .$$

The solution is the well-known biharmonic spline, or thin plate spline, ϕ(r)=r^{z} log r, r=∥x−xᵢ∥, with a polynomial of degree 1 (i.e. an affine function)

$$\hat{f} ( x ) = {\sum }_{i} {w}_{i} ϕ ( ‖ x - {x}_{i} ‖ ) + Ax + b . \qquad ( 11 )$$

Generalizations to higher dimensions yield polyharmonic splines. These splines maximize the surface fairness. From (11) it is also clear the polynomial doesn't depend on the structure of the point set and is common for all points.

4. Geometrically Principled Connections

In Section 3, we highlighted key similarities and differences between continuous RBFs and discrete graph convolution kernels. We then exposed how adding low-order polynomials to RBFs kernels is both beneficial to enable efficient fitting of flat functions, and deeply connected to regularization of the learned functions, and noted the polynomial component does not depend on spatial relationships. Based on these observations, we conjecture that graph convolution operators could, too, benefit from the addition of a low-order polynomial to ensure they can represent flat functions exactly, and learn functions of a vertex's features independently from its neighbours. We introduce a simple block that achieves both goals.

Inspired by equation (11), we propose to augment a generic graph convolution operator with affine skip connections, i.e., inter-layer connections with an affine transformation implemented as a fully connected layer. The output of the block is the sum of the two paths, as shown in FIG. 33.

Our block is designed to allow the fully connected layer to learn an affine transformation of the current feature map, and let the convolution learn a residue from a vertex's neighbors. For message passing, we obtain:

$${x}_{i}^{( k )} = {γ}^{( k )} ( {x}_{i}^{( k - 1 )} , {•}_{j ∈ ( i )} {ϕ}^{( k )} ( {x}_{i}^{( k - 1 )} , {x}_{j}^{( k - 1 )} , {e}_{i , j}^{( k - 1 )} ) ) + {A}^{( k )} {x}_{i}^{( k - 1 )} + {b}^{( k )} . \qquad ( 12 )$$

The fully connected layer could be replaced by an MLP to obtain non-linear connections, however, we argue the stacking of several layers creates sufficiently complex mappings by composition to not require deeper sub-networks in each block: a balance may be found between expressiveness and model complexity. Additionally, the analogy with TPS appears well-motivated for signals defined on surfaces. As a matter of notation, we refer to our block based on operator Conv with affine skip connections as Aff-Conv.

In equations (9), (11) and (12), the polynomial part does not depend on a vertex's neighbors, but solely on the feature at that vertex. This is similar to PointNet that learns a shared MLP on all points with no structural prior. In our block, the geometric information is readily encoded in the graph, while the linear layer is applied to all vertices independently, thus learning indirectly from the other points regardless of their proximity.

Residual blocks with projections. In He et al. (Kaiming He, Xiangyu Zhang, Shaoqing Ren, and Jian Sun. Deep residual learning for image recognition. In Proceedings of the IEEE Computer Society Conference on Computer Vision and Pattern Recognition, volume 2016-Decem, pages 770-778. IEEE, jun 2016), Eq. (2), the authors introduced a variation of residual blocks with a projection implemented as a linear layer. Their motivation is to handle different input and output sizes. We acknowledge the contribution of residual connections and will demonstrate our block provides the same benefits and more for GNNs.

5. Experimental Evaluation

Our experiments are designed to highlight different properties of affine skip connections when combined. We present the individual experiments, then draw conclusions based on their entirety. All implementation details (model architecture, optimizers, losses, etc.), and details about the datasets (number of samples, training/test split) are provided in Appendix A of the supplementary material.

5.1. Experimental design

Mesh reconstruction. The task is to reconstruct meshes with an auto-encoder architecture, and relates the most to interpolation. To validate the proposed approach, we firstly show the performance of attention-based models, MoNet and FeaStNet, on shape reconstruction on CoMA for different values of M. For a kernel size of M, we compare the vanilla operators (MoNet, FeaStNet), the blocks with residual skip connections (Res-MoNet, Res-FeaStNet), the blocks with affine skip connections (Aff-MoNet, Aff-FeaStNet), and the vanilla operators with kernel sizeM+1 (MoNet+, FeaSt-Net+)5. We evaluated kernel sizes 4, 9, and 14. We report the mean Euclidean vertex error and its standard deviation, and the median Euclidean error. Results with SplineCNN are shown in Appendix B of the supplementary material.

Mesh correspondence. The experimental setting is mesh correspondence, i.e., registration formulated as classification. We compare MoNet, FeaStNet and their respective blocks on the FAUST dataset. We purposefully do not include SpiralNet++ and ChebNet on this problem: the connectivity of FAUST is fixed and vertices are in correspondence already. These methods assume a fixed topology and therefore have an unfair advantage. We report the percentage of correct correspondences as a function of the geodesic error.

Mesh correspondence with GCN The GCN model is arguably the most popular graph convolution operator, and has been widely applied to problems on generic graphs thanks to its simplicity. However, its performance degrades quickly on meshes, which makes the entry bar higher for prototyping graph-based approaches in 3D vision. We investigate whether affine skip connections can improve the performance of GCN, and by how much. We choose the 3D shape correspondence task, in order to allow for comparison with the other models already included in this study. As detailed in the supplementary material, the network used in this experiment is relatively deep, with three convolution layers. Residual connections may be added to GCNs deeper than two layers to alleviate vanishing gradients. In order to prove affine skip connections have a geometric meaning, we may reduce the possibility that better performance comes solely from improved gradient flow. We include in this study a GCN block with vanilla residual connections (Res-GCN), in order to isolate the gradient flow improvements from the geometric improvements. Overall, we compare vanilla GCN, Res-GCN, and our Aff-GCN.

Graph classification. We compare MoNet, FeaStNet, and their respective residual and affine skip connection blocks on graph classification on Superpixel MNIST. The Superpixel MNIST dataset represents the MNIST images as graphs. We use 75 vertices per image. All models use a kernel size of 25. We include GIN (built with a 2-layer MLP) for the similarity of its update rule with our block, in the GIN-0 (∈=0) variant for its superior performance as observed previously. We compare GIN with GCN, Res-GCN, and Aff-GCN. Here, graph connectivity is not fixed. We report the classification accuracy.

Ablation study: separate weights for the centre vertex. To show the inclusion of the center vertex is necessary, we perform an ablation study of ChebNet, and SpiralNet++ on shape reconstruction on CoMA. From equation (3), we see the zero order term XΘ₀ is an affine function of the vertex features. We remove it from the expansion of ChebNet-(M+1) to obtain ChebNet-M†: X^{(k)}=L^{(M+1)}X^{(k-1)}Θ_{M+1}+ . . . +LX^{(k-1)}Θ₁. Both models have identical numbers of weight matrices, but ChebNet-M learns from the vertices alone at order 0. For SpiralNet++, the center vertex is the first in the sequence {vertex∥neighbors}. We rotate the filter (i.e. move it one step down the spiral) to remove the weight on the center vertex while keeping the same sequence length. We obtain SpiralNet++t. The number of weight matrices is constant. All models have kernel size 9.

Ablation study: self-loops vs. affine skip connections We also compare FeaStNet with and without self-loops (FeaStNett), and the matching blocks, on all experiments.

5.2. Results and discussion

Based on the evidence collected, we draw conclusions about specific properties of our affine skip connections.

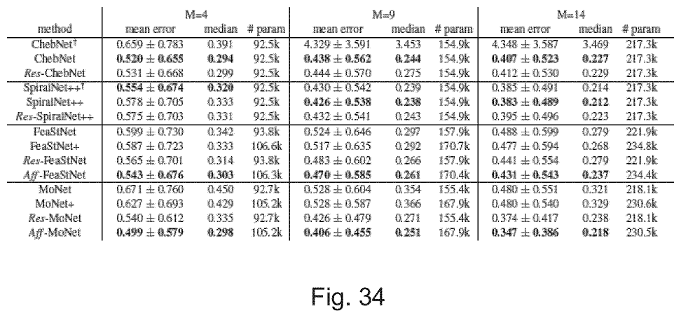

Parameter specificity. The results of varying the kernel size on shape reconstruction can be found in FIG. 34 along with the corresponding number of parameters for control. Increasing the kernel size by 1 (MoNet+, FeaStNet+) provides only a minor increase in performance, e.g., for M=9 and M=14, MoNet and MoNet+ have the same mean Euclidean error and the median error of MoNet with M=9 actually increases by 3:4%. In contrast, the affine skip connections always drastically reduce the reconstruction error, for the same number of additional parameters. In particular, the mean Euclidean error of MoNet decreased by 25:6% for M=4, and by 23:1% for M=9. We conclude our affine skip connections have a specific different role and augment the representational power of the networks beyond simply increasing the number of parameters. Our block with MoNet achieves the new state of the art performance on this task.

What do affine skip connections learn? In FIG. 36, we observe the linear layers in the connections learned information common to all shapes. This result strengthens our analogy with the polynomial terms in RBF interpolation: the coefficients of the polynomial function are learned from all data points and shared among them. In one dimension, this can be pictured as learning the trend of a curve. Our visualizations are consistent with this interpretation.

Vertex-level representations. We report the mesh correspondence accuracy as a function of the geodesic error for FeaStNet, MoNet, and the blocks in FIG. 38A. We observe consistent performance improvements for both operators. The performance difference is remarkable for MoNet: for a geodesic error of 0, the accuracy improved from 86:61% to 94:69%. Aff-MoNet is the new state of the art performance on this problem (Excluding methods that learn on a fixed topology). We conclude affine skip connections improve vertex-level representations.

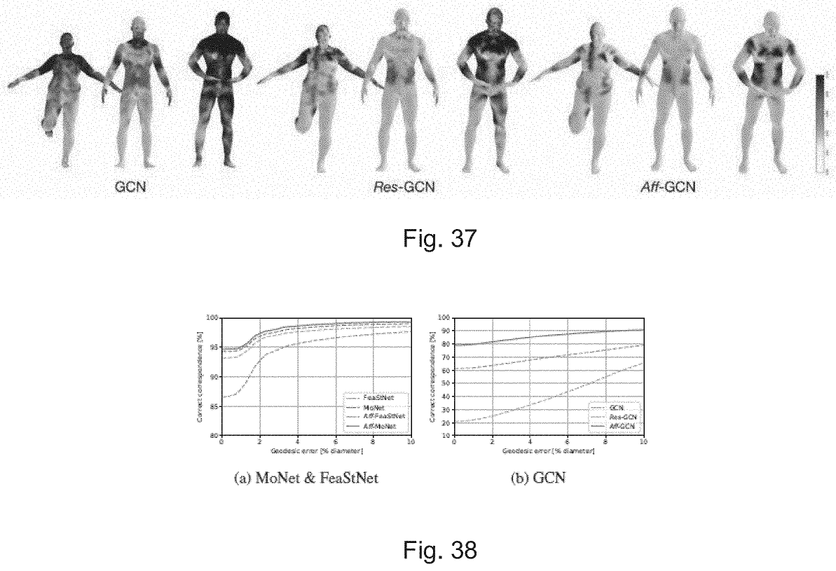

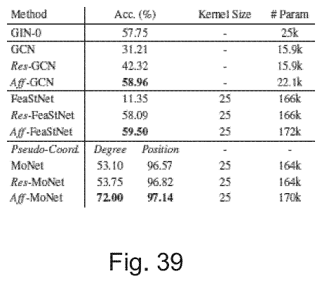

Laplacian smoothing and comparison to residuals. We show the performance of GCN and its residual and affine blocks in FIG. 38B. The accuracy of vanilla GCN is only around 20%. We can hypothesize this is due to the equivalence of GCN with Laplacian smoothing—blurring thefeatures of neighboring vertices and losing specificity—or to the vanishing gradient problem. Our block outperforms vanilla residuals by a large margin: the classification rate of Aff-GCN is nearly 79% while Res-GCN only reaches 61.27%. Visually (FIG. 37), Res-GCN provides marked improvements over GCN, and Aff-GCN offers another major step-up. A similar trend is seen in FIG. 34 and FIG. 39. Previously it has been observed a minor performance increase between vanilla residuals and residual connections with projection, that they attributed to the higher number of parameters. The differences we observe are not consistent with such marginal improvements. This shows not only our approach provides all the benefits of residuals in solving the vanishing gradient problem, it achieves more on geometric data, and that the improvements are not solely due to more trainable parameters or improved gradient flow. In particular, with affine skip connections, Eq. 4 of Li et al 2018 becomes σ(\tilde{L}H^{(l)}Θ^{(l)}+H^{(l)}W^{(l)}, with L the augmented symmetric Laplacian, and W^{(l)} the parameters of the affine skip connection. Thus, the Aff-GCN block is no longer equivalent to Laplacian smoothing.

Discriminative power. Our results on Superpixel MNIST are presented in FIG. 39. Our affine skip connections improve the classification rate across the board. GCN with affine skip connections outperform GIN-0 by over 1 percentage point, with 12% fewer trainable parameters. This result shows Aff-GCN offers competitive performance with a smaller model, and suggests the augmented operator is significantly more discriminative than GCN. Assuming the terminology used previously, FeaStNet employs a mean aggregation function, a choice known to significantly limit the discriminative power of GNNs and which could explain its very low accuracy in spite of its large (166 k) number of parameters. In contrast, Aff-FeaStNet is competitive with Aff-GCN and outperforms GIN-0. As GIN is designed to be as powerful of the WL test, these observations suggest affine skip connections improve the discriminative power of graph convolution operators. As a result, Aff-MoNet outperformed the current state of the art, for coordinate-based and degree-based pseudo-coordinates.

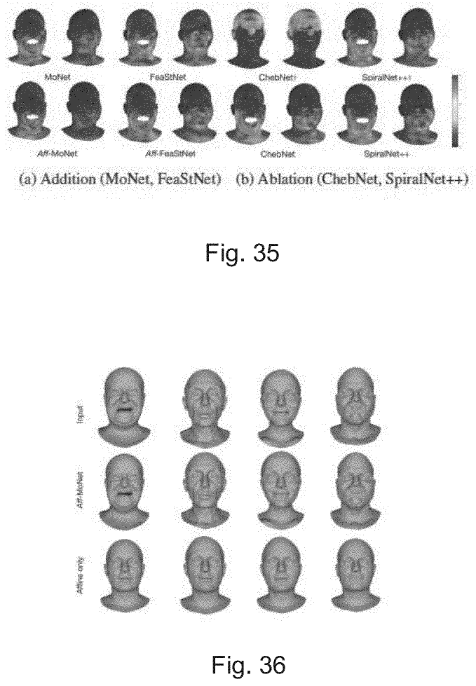

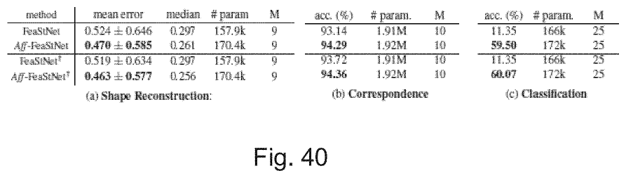

Role of the center vertex. As seen in the first six rows of FIG. 34, the performance of the models is higher with weights for the center vertex, especially for ChebNet. Note the comparison is at identical numbers of parameters. FIG. 35 provides sample ablation and addition results. This shows convolution operators need to learn from the center vertices. We found that removing self-loops in FeaStNet actually increased the performance for both the vanilla and the block operators. FIG. 40 shows results on all experiments. The affine skip connection consistently improved the performance of models regardless of the self-loops. We conclude graph convolution operators should be able to learn specifically from the center vertex of a neighborhood, independently from its neighbors. A similar observation has been made previously where independent parameters for the center vertex are shown to be required for graph convolution operators to be as discriminative as the WL test.

6. Conclusion

By relating graph neural networks to the theory of radial basis functions, we introduce geometrically principled connections that are both easily implemented, applicable to a broad range of convolution operators and graph or mesh learning problems, and highly effective. We show our method extends beyond surface reconstruction and registration, and can dramatically improve performance on graph classification with arbitrary connectivity. Our MoNet block achieves state of the art performance and is more robust to topological variations than sequence (SpiralNet++) or spectrum-based (ChebNet) operators. We further demonstrate our blocks improve on vanilla residual connections for graph neural networks. We believe our approach is therefore interesting to the broader community. Future work should study whether affine skip connections have regularization effects on the smoothness of the learned convolution kernels.

Supplementary Material

This supplementary material provides further details that is not be included in the main text: Section A provides implementation details on the experiments used in Section 5 of the paper, and Section B further describes the results obtained by SplineCNN with and without the proposed affine skip connections on the task of shape reconstruction.

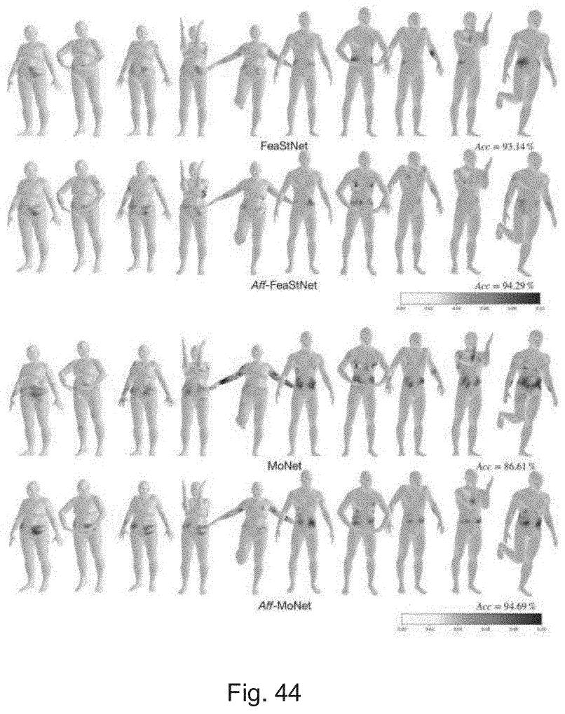

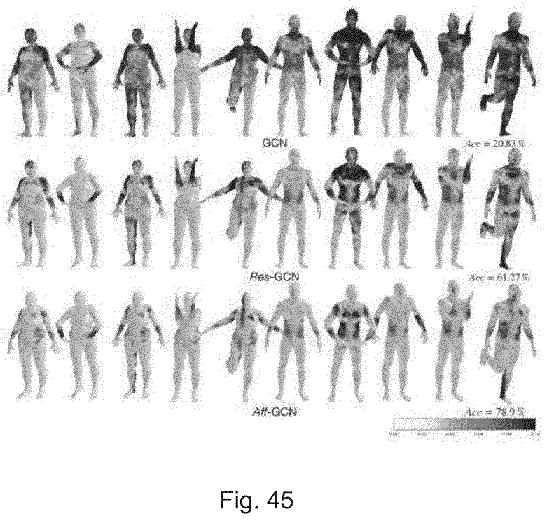

FIGS. 41 and 43 show the faces reconstructed by autoencoders built with each convolution operator presented in FIG. 34 of the paper, at kernel size 14. FIGS. 44 and 45 show the visualization of shapes colored by the pointwise geodesic error of different methods on the FAUST humans dataset.

A. Implementation Details

For all experiments we initialize all trainable weight parameters with Glorot initialization and biases with constant value 0. The only exception is FeaStNet, for which weight parameters (e.g. W, , c) are drawn from N(0; 0:1). The vertex features fed to the models are the raw 3D Cartesian coordinates (for the CoMA and FAUST datasets) or the 1D superpixel intensity (for the Superpixel MNIST datase). The pseudo-coordinates used in MoNet and SplineCNN are the pre-computed relative Cartesian coordinates of connected nodes. Note that in Superpixel MNIST classification experiments, we compared the performance of MoNet using pseudo-coordinates computed from relative Cartesian coordinates which considering vertex positions as well as globally normalized degree of target nodes for the sake of the fairness. All experiments are ran on a single NVIDIA RTX 2080 Ti.

Shape reconstruction. We perform experiments on the CoMA dataset. We follow the interpolation experimental setting as used with the CoMA dataset, the dataset is split in training and test sets with a ratio of 9:1. We normalize the input data by subtracting the mean and dividing by the standard deviation obtained on the training set and we de-normalize the output before visualization. We quantitatively evaluate models with the pointwise Euclidean error (we report the mean, standard deviation, and median values) and the visualizations for qualitative evaluation.

The experimental setting is identical to Gong et al. 2019 and outlined in the application earlier. The network architecture is 3×{Conv(32)→Pool(4)}→{Conv(64)→Pool(4)}→FC(16) for the encoder, and a symmetrical decoder with one additional Conv(3) output to reconstruct 3D coordinates, with ELU activations after each convolutional layer except on the output layer that has no activate. We used the same downsampling and upsampling approach introduced in Ranjan et al.. Models are trained with Adam for 300 epochs with an initial learning rate of 0.001 and a learning rate decay of 0.99 per epoch, minimizing the [symbol] vertex-wise loss. The batch size is 32.

Mesh correspondence. We perform experiments on the FAUST dataset, containing 10 scanned human shapes in 10 different poses, resulting in a total of 100 non-watertight meshes with 6,890 nodes each. The first 80 subjects in FAUST were used for training and the remaining 20 subjects for testing. Correspondence quality is measured according to the Princeton benchmark protocol, counting the percentage of derived correspondences that lie within a geodesic radius r around the correct node.

We use the single scale architecture of with an added dropout layer. We obtain the architecture Lin(16)→Conv(32)→Conv(64)→Conv(128)→Lin(256)→Dropout(0:5)→Lin(6890), where Lin(0) denotes a 1×1 convolution layer that produces 0 output features per node. We use ELU non-linear activation functions after each Conv layer, and after the first Lin layer. We use a softmax activation for the last layer. Models are trained with the standard cross-entropy loss for 1000 epochs. We use the Adam optimizer with an initial learning rate of 0:001 for MoNet (with and without affine skip connections) and GCN (vanilla, Res and Aff), and an initial learning rate of 0:01 for FeaStNet (with and without affine skip connections). We decay the learning rate by a factor of 0:99 every epoch for MoNet (with and without affine skip connections) and GCN (vanilla, Res and Aff), and a factor of 0:5 every 100 epochs for FeaStNet (with and without affine skip connections). We use a batch size of 1. Note that for Res-GCN, we use zero-padding shortcuts for mismatched dimensions.

Superpixel MNIST classification. Experiments are conducted on the Superpixel MNIST dataset, where MNIST images are represented as graphs with different connectivity, each containing 75 vertices. The dataset is split into training and testing sets of 60 k and 10 k samples respectively.

Our architecture has three convolutional layers, and reads Conv(32)→Pool(4)→Conv(64)→Pool(4)→Conv(64)→AvgP→FC(128)→Dropout(0:5)→FC(10). Pool(4) is based on the Graclus graph coarsening approach, downsampling graphs by approximately a factor of 4. AvgP denotes a readout layer that averages features in the node dimension. As for the nonlinearity, ELU activation functions are used after each layer except for the last layer that uses softmax. We train networks using the Adam optimizer for 500 epochs, with an initial learning rate of 0:001 and learning rate decay of 0:5 after every 30 epochs. We minimize the cross-entropy loss. The batch size is 64 and we use '2 regularization with a weight of 0:0001. For each GIN-0 layer, we use a 2-layer MLP with ReLU activations, and batch normalization right after each GIN layer.

B. Further Results with SplineCNN

For the sake of completeness, we show additional results with the SplineCNN operator to validate the proposed block. We report the performance on the shape reconstruction benchmark. SplineCNN is conceptually similar by definition to MoNet, with a kernel function g_{Θ}(uᵢⱼ) represented on the tensor product of weighted B-Spline functions, that takes as input relative pseudo-coordinates uᵢⱼ. SplineCNN and MoNet both leverage the advantages of attention mechanisms to learn intrinsic features. To follow the definitions in Section 2 in the paper, we formulate the SplineCNN convolution as

$${x}_{i}^{( k )} = \frac{1}{\vert ( i ) \vert} {\sum }_{j ∈ ( i )} {x}_{j}^{( k - 1 )} \cdot g Θ ( {u}_{i , j} ) . \qquad ( 13 )$$

Let m=(m₁, . . . , m_{d}) the d-dimensional kernel size. For 3D data, the number of trainable weight matrices is M=Πᵢ₌₁^{d} mᵢ=m³, with equal kernel size in each three dimension.

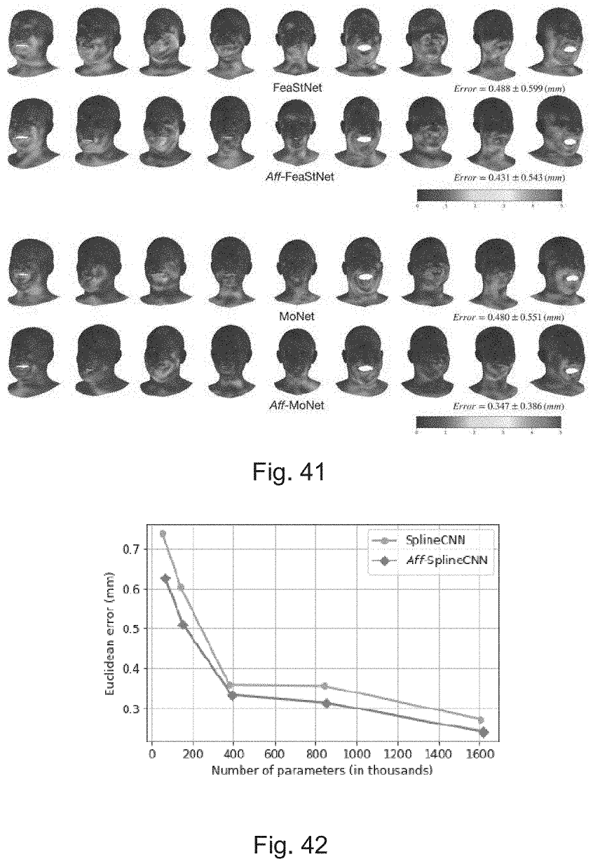

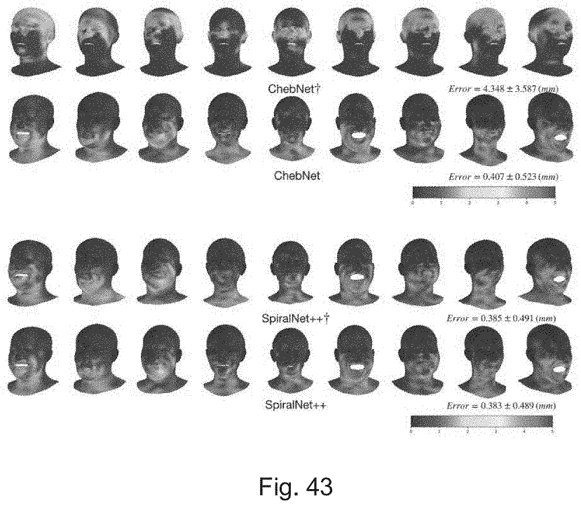

We show the results (FIG. 42) obtained with SplineCNN and kernel sizes m=1; . . . , 5. We fix the B-Spline degree to 1, for both with and without affine skip connections (It should be noted that the implementation of SplineCNN provided by the author already uses a separate weight for the center vertex. To allow for a fair assessment of the affine skip connections, we tacitly assumed here that the propagation of SplineCNN is only based on Eq. 13). The rest of the experimental setup and hyperparameters is identical to Section A. Clearly, as shown in FIG. 42, the performance of Aff-SplineCNN is consistently better than that of SplineCNN, achieving the smallest error of all models at 0:241 with kernel size 5 in each dimension (i.e. 125 in total as the growth rate is cubical). Interestingly, SplineCNN (Aff-SplineCNN) does not outperform MoNet (Aff-MoNet) when the number of weight matrices is the same. For instance, for M=8, the mean Euclidean errors of MoNet and Aff-MoNet are 0:531 and 0:397 respectively, whereas the mean Euclidean errors of SplineCNN and Aff-SplineCNN are 0:605 and 0:501.

Modifications

It will be appreciated that various modifications may be made to the embodiments hereinbefore described. Such modifications may involve equivalent and other features which are already known in the design and use of geometric neural network methods, systems and component parts thereof and which may be used instead of or in addition to features already described herein. Features of one embodiment may be replaced or supplemented by features of another embodiment.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. A geometric decoder method comprising:
receiving an input comprising at least an input representation;
decoding the input to generate an output geometric domain by applying on the input representation at least an intrinsic convolution layer, wherein the intrinsic convolutional layer comprises a consistent local ordering of data points on the geometric domain.

2. The method of claim 1 wherein the output geometric domain is selected from the group consisting of:
a manifold;
a parametric surface;
an implicit surface;
a mesh;
a point cloud;
an undirected weighted or unweighted graph; or
a directed weighted or unweighted graph.

3. The method of claim 1 wherein the input comprises a consistent local ordering.

4. The method of claim 1 wherein the input representation is a vector.

5. The method of claim 1 wherein the output geometric domain comprises point data and structure data.

6. The method of claim 5 wherein the structure data is selected from the group consisting of:
a neighbour graph;
a triangular mesh; or
a simplicial complex.

7. The method of claim 5 wherein the point data is computed and the input comprises the structure data.

8. The method of claim 5 wherein the structure data is a template geometric domain.

9. The method of claim 1 wherein determining the consistent local ordering of data points comprises determining the local neighbours of each data point on the geometric domain and ordering said local neighbours in a consistent way.

10. The method of claim 1 wherein the consistent local ordering of data points comprises the local neighbours of each data point along a trajectory, the trajectory being selected from the group consisting of:
a spiral; or
a set of one or more concentric circles.

11. The method of claim 1 wherein the consistent local ordering of data points is generated, for each point, by:
selecting a first point;
selecting a second point adjacent to said first point;
selecting a clockwise or counter-clockwise direction;
selecting the next point in the selected direction around the first point on the geometric domain which is closest to the first point and which has not already been selected; and
performing the previous step until a desired number of points have been selected.

12. The method of claim 11 wherein selecting the second point comprises:
fixing the first point on a template domain;
selecting the second point wherein the second point has the shortest geodesic distance to the first point on the template domain.

13. The method of claim 1, wherein applying intrinsic convolution layer comprises the steps of:
obtaining the consistent local ordering of data points on the geometric domain;
extracting features associated with each of said data points;
applying a set of weights to the extracted features using the consistent local ordering of data points to compute a new set of output features; and
outputting the output features.

14. The method of claim 13, wherein the set of weights is determined by a learning procedure.

15. The method according to claim 1, wherein a plurality of intrinsic convolutional layers are applied in sequence.

16. The method according to claim 15, wherein the plurality of intrinsic convolutional layers are applied on a hierarchy of geometric domains.

17. The method according to claim 16, wherein the hierarchy of geometric domains comprises at least one of
a hierarchy of point data;
a hierarchy of structure data.

18. The method according to claim 16, wherein at least some of subsequent geometric domains in the hierarchy of geometric domains are supersets of the previous geometric domains in the hierarchy of geometric domains.

19. The method according to claim 15, further comprising applying an upsampling operation between the application of each intrinsic convolutional layers.

20. The method according to claim 19, wherein the upsampling operation transfers data across two subsequent geometric domains.

21. The method according to claim 16, wherein each geometric domain in the hierarchy of geometric domains comprises a respective consistent local ordering of data points on said geometric domain.

22. A method according to claim 1 wherein the input representation is generated by an encoder applied to input data.

23. A method according to claim 22 wherein the input data is selected from the group consisting of one of:
an image;
a point cloud;
a mesh;
a manifold;
an implicit surface;
a signed distance function;
a parametric surface; or
a graph.

24. A method according to claim 22 wherein the encoder is selected from the group consisting of one of:
a convolutional neural network;
a point cloud neural network;
a convolutional mesh neural network; or
a graph neural network.

25. A method according to claim 22 wherein the encoder architecture is identical to that of the decoder.

26. A method according claim 22, wherein the encoder comprises at least an intrinsic convolution layer.

27. A method according to claim 1 further comprising at least one affine skip connection.

28. A method according to claim 16 further comprising at least one affine skip connection across at least two intrinsic convolution layers.

29. A method according to claim 22 further comprising at least one affine skip connection in at least one of the decoder or encoder.
